(19) United States
(12) Patent Application Publication
(10) Pub. No.: US 2025/0286603 A1
(43) Pub. Date: Sep. 11, 2025

(54) INTEGRATED MILLIMETER WAVE (IMMW) BEAM TRAINING FOR MULTI-LINK OPERATION (MLO)

(71) Applicant: QUALCOMM Incorporated, San Diego, CA (US)

(72) Inventors: Abhishek Pramod PATIL, San Diego, CA (US); Lin YANG, San Diego, CA (US); George CHERIAN, San Diego, CA (US); Giovanni CHISCI, San Diego, CA (US); Gaurang NAIK, San Diego, CA (US); Alfred ASTERJADHI, San Diego, CA (US)

(21) Appl. No.: 19/075,531

(22) Filed: Mar. 10, 2025

Related U.S. Application Data
(60) Provisional application No. 63/563,795, filed on Mar. 11, 2024.

(51) Int. Cl. H04B 7/06; H04W 24/10; H04W 56/00; H04W 76/15

(52) U.S. Cl. CPC H04B 7/06952; H04W 24/10; H04W 56/0045; H04W 76/15

(57) ABSTRACT

This disclosure provides methods, components, devices, and systems for integrated millimeter wave (IMMW) beam training for multi-link operation. Some aspects more specifically relate to beam sweeping and reporting for partnered 60 Gigahertz (GHz) and sub-7 GHz links. In some implementations, an access point (AP) multi-link device (MLD) may communicate with a non-AP MLD via a first omni-directional link, such as a sub7 link, and a second directional link, such as a 60 GHz link. The AP MLD may use the omni-directional link to configure one or more parameters and report feedback for the directional link. For example, the AP MLD may transmit, to the non-AP MLD via the first link, an indication of a timing synchronization function (TSF) value associated with the second link of the AP MLD. The AP MLD and the non-AP MLD may use the TSF value to support beam training operations for the second link.

### PRIORITY INFORMATION

The present Application for Patent claims priority under 35 U.S.C. § 119 to U.S. Provisional Patent Application No. 63/563,795 by Patil et al., filed Mar. 11, 2024 and entitled “INTEGRATED MILLIMETER WAVE (IMMW) BEAM TRAINING FOR MULTI-LINK OPERATION (MLO),” which is assigned to the assignee hereof and hereby expressly incorporated by reference herein.

### TECHNICAL FIELD

This disclosure relates generally to wireless communication and, more specifically, to integrated millimeter wave (IMMW) beam training for multi-link operation (MLO).

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a non-access point (AP) multi-link device (MLD). The non-AP MLD may include a processing system that includes processor circuitry and memory circuitry that stores code. The processing system may be configured to cause the non-AP MLD to communicate with an AP MLD via a first link corresponding to a first frequency band associated with omni-directional communications and obtain, via the first link, an indication of a first timing synchronization function (TSF) value associated with a second link between the AP MLD and the non-AP MLD. The processing system may be further configured to cause the non-AP MLD to communicate, with the AP MLD, a report indicating a second TSF value associated with reception of a sweep packet of one or more sweep packets for a beam sweeping procedure and communicate with the AP MLD via the second link corresponding to a second frequency band associated with directional communications in accordance with the beam sweeping procedure and the first TSF value associated with the second link.

Another innovative aspect of the subject matter described in this disclosure can be implemented in a method for wireless communications at a non-AP MLD. The method may include communicating with an AP MLD via a first link corresponding to a first frequency band associated with omni-directional communications and receiving, via the first link, an indication of a first TSF value associated with a second link between the AP MLD and the non-AP MLD. The method may further include communicating, with the AP MLD, a report indicating a second TSF value associated with reception of a sweep packet of one or more sweep packets for a beam sweeping procedure and communicating with the AP MLD via the second link corresponding to a second frequency band associated with directional communications in accordance with the beam sweeping procedure and the first TSF value associated with the second link.

Another innovative aspect of the subject matter described in this disclosure can be implemented in a non-AP MLD. The non-AP MLD may include means for communicating with an AP MLD via a first link corresponding to a first frequency band associated with omni-directional communications and means for receiving, via the first link, an indication of a first TSF value associated with a second link between the AP MLD and the non-AP MLD. The non-AP MLD may further include means for communicating, with the AP MLD, a report indicating a second TSF value associated with reception of a sweep packet of one or more sweep packets for a beam sweeping procedure and means for communicating with the AP MLD via the second link corresponding to a second frequency band associated with directional communications in accordance with the beam sweeping procedure and the first TSF value associated with the second link.

Another innovative aspect of the subject matter described in this disclosure can be implemented in a non-transitory computer-readable medium storing code for wireless communications. The code may include instructions executable by one or more processors to communicate with an AP MLD via a first link corresponding to a first frequency band associated with omni-directional communications and receive, via the first link, an indication of a first TSF value associated with a second link between the AP MLD and the non-AP MLD. The code may further include instructions executable by the one or more processors to communicate, with the AP MLD, a report indicating a second TSF value associated with reception of a sweep packet of one or more sweep packets for a beam sweeping procedure and communicate with the AP MLD via the second link corresponding to a second frequency band associated with directional communications in accordance with the beam sweeping procedure and the first TSF value associated with the second link.

Some implementations of the non-AP MLDs, method, and non-transitory computer-readable medium described herein may further include operations, features, means, or instructions for transmitting or otherwise outputting the one or more sweep packets, where the one or more sweep packets include a set of multiple sweep packets associated with a set of multiple respective transmit beams for the beam sweeping procedure, and where a sweep packet transmission for the set of multiple sweep packets corresponds to a respective TSF value of a set of multiple TSF values and the report may be obtained in accordance with the beam sweeping procedure.

Some implementations of the non-AP MLDs, method, and non-transitory computer-readable medium described herein may further include operations, features, means, or instructions for selecting a transmit beam for the second link that corresponds to the sweep packet of the one or more sweep packets in accordance with the report indicating the second TSF value associated with the reception of the sweep packet.

Some implementations of the non-AP MLDs, method, and non-transitory computer-readable medium described herein may further include operations, features, means, or instructions for receiving or otherwise obtaining the one or more sweep packets for the beam sweeping procedure, where the one or more sweep packets are associated with one or more respective TSF values, and the report is outputted in accordance with obtaining the one or more sweep packets and the sweep packet satisfying a signal strength threshold.

Some implementations of the non-AP MLDs, method, and non-transitory computer-readable medium described herein may further include operations, features, means, or instructions for operating in a non-standalone (NSA) mode, where the first link includes a partner link for the second link in the NSA mode.

Some implementations of the non-AP MLDs, method, and non-transitory computer-readable medium described herein may further include operations, features, means, or instructions for triggering the beam sweeping procedure in accordance with establishment of an association with the AP MLD, an inactivity timer for the non-AP MLD, a reference signal indicating beam misalignment for the second frequency band, or any combination thereof.

Another innovative aspect of the subject matter described in this disclosure can be implemented in an AP MLD. The AP MLD may include a processing system that includes processor circuitry and memory circuitry that stores code. The processing system may be configured to cause the AP MLD to communicate with a non-AP MLD via a first link corresponding to a first frequency band associated with omni-directional communications and output, via the first link, an indication of a first TSF value associated with a second link between the AP MLD and the non-AP MLD. The processing system may be further configured to cause the AP MLD to communicate, with the non-AP MLD, a report indicating a second TSF value associated with reception of a sweep packet of one or more sweep packets for a beam sweeping procedure and communicate with the non-AP MLD via the second link corresponding to a second frequency band associated with directional communications in accordance with the beam sweeping procedure and the first TSF value associated with the second link.

Another innovative aspect of the subject matter described in this disclosure can be implemented in a method for wireless communications at an AP MLD. The method may include communicating with a non-AP MLD via a first link corresponding to a first frequency band associated with omni-directional communications and transmitting, via the first link, an indication of a first TSF value associated with a second link between the AP MLD and the non-AP MLD. The method may further include communicating, with the non-AP MLD, a report indicating a second TSF value associated with reception of a sweep packet of one or more sweep packets for a beam sweeping procedure and communicating with the non-AP MLD via the second link corresponding to a second frequency band associated with directional communications in accordance with the beam sweeping procedure and the first TSF value associated with the second link.

Another innovative aspect of the subject matter described in this disclosure can be implemented in an AP MLD. The AP MLD may include means for communicating with a non-AP MLD via a first link corresponding to a first frequency band associated with omni-directional communications and means for transmitting, via the first link, an indication of a first TSF value associated with a second link between the AP MLD and the non-AP MLD. The AP MLD may include means for communicating, with the non-AP MLD, a report indicating a second TSF value associated with reception of a sweep packet of one or more sweep packets for a beam sweeping procedure and means for communicating with the non-AP MLD via the second link corresponding to a second frequency band associated with directional communications in accordance with the beam sweeping procedure and the first TSF value associated with the second link.

Another innovative aspect of the subject matter described in this disclosure can be implemented in a non-transitory computer-readable medium storing code for wireless communications. The code may include instructions executable by one or more processors to communicate with a non-AP MLD via a first link corresponding to a first frequency band associated with omni-directional communications and transmit, via the first link, an indication of a first TSF value associated with a second link between the AP MLD and the non-AP MLD. The code may further include instructions executable by the one or more processors to communicate, with the non-AP MLD, a report indicating a second TSF value associated with reception of a sweep packet of one or more sweep packets for a beam sweeping procedure and communicate with the non-AP MLD via the second link corresponding to a second frequency band associated with directional communications in accordance with the beam sweeping procedure and the first TSF value associated with the second link.

Some implementations of the AP MLDs, method, and non-transitory computer-readable medium described herein may further include operations, features, means, or instructions for transmitting or otherwise outputting the one or more sweep packets, where the one or more sweep packets include a set of multiple sweep packets associated with a set of multiple respective transmit beams for the beam sweeping procedure, and where a sweep packet transmission for the set of multiple sweep packets corresponds to a respective TSF value of a set of multiple TSF values and the report is obtained in accordance with the beam sweeping procedure.

Some implementations of the AP MLDs, method, and non-transitory computer-readable medium described herein may further include operations, features, means, or instructions for selecting a transmit beam for the second link that corresponds to the sweep packet of the one or more sweep packets in accordance with the report indicating the second TSF value associated with the reception of the sweep packet.

Some implementations of the AP MLDs, method, and non-transitory computer-readable medium described herein may further include operations, features, means, or instructions for receiving or otherwise obtaining the one or more sweep packets for the beam sweeping procedure, where the one or more sweep packets are associated with one or more respective TSF values, and the report is outputted in accordance with obtaining the one or more sweep packets and the sweep packet satisfying a signal strength threshold.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for wireless communications between a wireless access point (AP) and one or more wireless stations (STAs).

FIG. 3 shows an example physical layer (PHY) protocol data unit (PPDU) usable for wireless communications between a wireless AP and one or more wireless STAs.

FIG. 4 shows an example of a signaling diagram that supports techniques for integrated millimeter wave (IMMW) beam training for multi-link operation (MLO).

FIG. 5 shows an example of a signaling timeline that supports IMMW beam training for MLO.

FIG. 6 shows an example of a reporting format that supports IMMW beam training for MLO.

FIG. 7 shows examples of preemption procedures that support IMMW beam training for MLO.

FIGS. 8 and 9 show block diagrams of example wireless communication devices that support IMMW beam training for MLO.

FIG. 10 shows a flowchart illustrating an example process performable by or at a non-AP multi-link device (MLD) that supports IMMW beam training for MLO.

FIG. 11 shows a flowchart illustrating an example process performable by or at an AP MLD that supports IMMW beam training for MLO.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)), or 6G standards promulgated by the 3rd Generation Partnership Project (3GPP), among others. The described examples can be implemented in any suitable device, component, system, or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO), and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some WLANs, wireless communication devices may operate via the 60 gigahertz (GHz) frequency band. For example, a wireless communication device may communicate radio signals between 30 GHz and 300 GHz, such as via the 60 GHz frequency band, with wavelengths between 1 and 10 millimeters (mms). Such communications with wavelengths between 1 and 10 mms may be referred to as millimeter wave (mmW) communications. A WLAN supporting such mmW communications may use integrated mmW (IMMW) techniques to support operations via the 60 GHz frequency band. The wireless communication devices may use directional communications to manage relatively high attenuation losses associated with the 60 GHz frequency band. To support directional communications, the wireless communication devices may perform beam sweeping operations, such as beam training, to select the directional beams to use for communications. However, such beam sweeping operations may involve significant processing and signaling overhead.

Various aspects relate generally to IMMW beam training for multi-link operation (MLO). Some aspects more specifically relate to beam sweeping and reporting procedures using partnered links, such as 60 gigahertz (GHz) and sub-7 GHz (sub7) links. A sub7 link may be an example of a wireless communication link supporting communications via an operating channel with an operating frequency below a 7 GHz frequency band, such as a 2.4 GHz frequency band, a 5 GHz frequency band, or a 6 GHz frequency band. In some implementations, an access point (AP) multi-link device (MLD) may communicate with a non-AP MLD via a first link and a second link. The first link, such as a sub7 link or another link, may support omni-directional communications, while the second link, such as a 60 GHz link or another link, may support directional, beam-based communications. The AP MLD may use the omni-directional link to configure one or more parameters for the directional link. For example, the AP MLD may transmit, to the non-AP MLD via the first link, an indication of a timing synchronization function (TSF) value associated with the second link of the AP MLD. TSF may be an example of a mechanism to synchronize timing between wireless communication devices in some wireless communication systems, such as Wi-Fi systems. The TSF value may be an indication of a timestamp (such as a value in microseconds) for a timer, such as a TSF timer, at a wireless communication device. In some implementations, the TSF value may be an example of a TSF offset value between the first link and the second link (such as a difference in microseconds between a TSF timer tracking timing synchronization for the first link and a TSF timer tracking timing synchronization for the second link). The AP MLD and the non-AP MLD may use the TSF value to support beam training operations for the second link. In some implementations, the AP MLD may use the sub7 link to configure timing for sweep packet transmissions of a beam sweeping procedure via the 60 GHz frequency band. The indicated TSF value may ensure coordination of sweep packet transmission timing and sweep packet reception timing for the AP MLD and the non-AP MLD. In some implementations, the AP MLD, the non-AP MLD, or both may use short sweep packets that are identifiable according to the reception timing of the sweep packets rather than information included within the sweep packets. Additionally, or alternatively, the MLDs may use the sub7 link to provide feedback for the beam sweeping procedures performed via the 60 GHz frequency band. In some implementations, the AP MLD may perform transmit beam sweeping procedures for multiple non-AP MLDs during a transmit period that is common for the multiple non-AP MLDs. The non-AP MLDs may monitor the 60 GHz frequency band during the common transmit period and may aggregate corresponding beam training feedback for reporting via the sub7 link. Additionally, or alternatively, the AP MLD may periodically transmit updated TSF information to the non-AP MLD via the sub7 link or the 60 GHz link.

Particular aspects of the subject matter described in this disclosure can be implemented to realize one or more of the following potential advantages. In some implementations, by indicating TSF values via the sub7 link, the AP MLD may improve timing coordination between the AP MLD and the non-AP MLD for 60 GHz beam training procedures. Such timing coordination may support sweep packets that are identifiable according to reception timing rather than information included within the sweep packets. Accordingly, the described techniques may support reducing the size of the sweep packets used for transmit beam sweeping by removing a training sequence, sector identifier information, or both from the sweep packets. Reducing the sweep packet sizes may reduce the latency and improve the signaling overhead associated with beam sweeping procedures for the 60 GHz frequency band. Additionally, or alternatively, by performing the transmit beam sweeping in a common transmit period via the 60 GHz band, the AP MLD may improve a processing and signaling overhead associated with beam training procedures for multiple non-AP MLDs. In some implementations, the AP MLD, the non-AP MLDs, or both, may facilitate timely delivery of the beam training feedback by aggregating feedback reporting via the sub7 link, improving the latency associated with beam training procedures for the 60 GHz link. Additionally, or alternatively, by transmitting updated TSF information, the AP MLD may protect against clock drift, improving timing coordination between the AP MLD and the non-AP MLD.

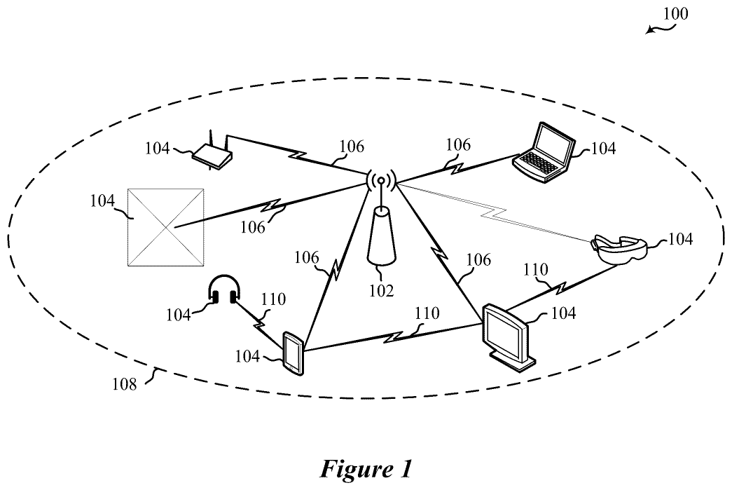

FIG. 1 shows a pictorial diagram of an example wireless communication network 100. According to some aspects, the wireless communication network 100 can be an example of a WLAN such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, 802.11bn, and the forthcoming 802.11bq standard). In some other implementations, the wireless communication network 100 can be an example of a cellular radio access network (RAN), such as a 5G or 6G RAN that implements one or more cellular protocols such as those specified in one or more 3GPP standards. In yet some other implementations, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other implementations, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications, or services.

The wireless communication network 100 may include numerous wireless communication devices including at least one AP 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G, or 6G) base stations or other cellular network nodes such as a Node B, an evolved Node B (eNB), a gNB, a transmission reception point (TRP), or another type of device or equipment included in a RAN, including Open-RAN (O-RAN) network entities, such as a central unit (CU), a distributed unit (DU), or a radio unit (RU). The AP 102 may be referred to as an AP STA or an AP MLD, among other examples.

Each of the STAs 104 also may be referred to as a mobile station (MS), a mobile device, a mobile handset, a wireless handset, an access terminal (AT), a user equipment (UE), a subscriber station (SS), a subscriber unit, a non-AP STA, or a non-AP MLD, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) or TSF value for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests via each channel to be scanned and listens for probe responses from APs 102. Each STA 104 may identify, determine, ascertain, or select an AP 102 with which to associate in accordance with the scanning information obtained through the passive or active scans and may perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In some such implementations, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted via a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control (AGC), and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be, and 802.11bn standard amendments may be transmitted over one or more of the 2.4 GHz, 5 GHz, or 6 GHz bands, each of which is divided into multiple 20 MHz channels. As such, these PPDUs are transmitted via a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a transmit opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend, and communicate using multiple primary 20 MHz channels. Such monitoring of multiple primary 20 MHz channels may be sequential such that, responsive to determining, ascertaining, or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

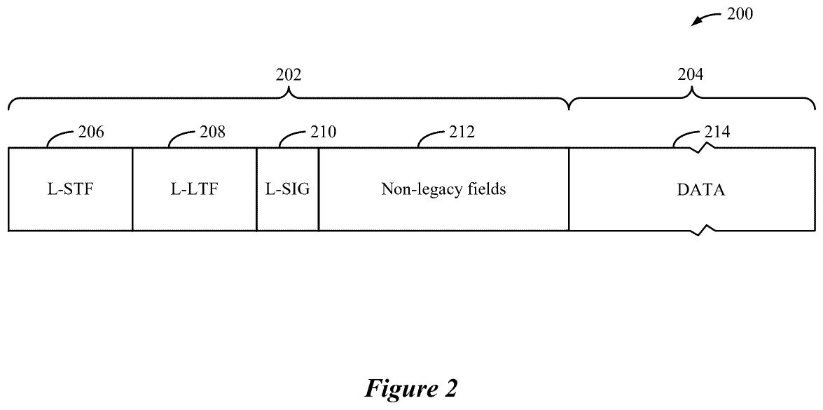

FIG. 2 shows an example protocol data unit (PDU) 200 usable for wireless communications between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble (such as the preamble 202) and a PHY payload (such as the payload 204). For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and AGC. The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208, and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

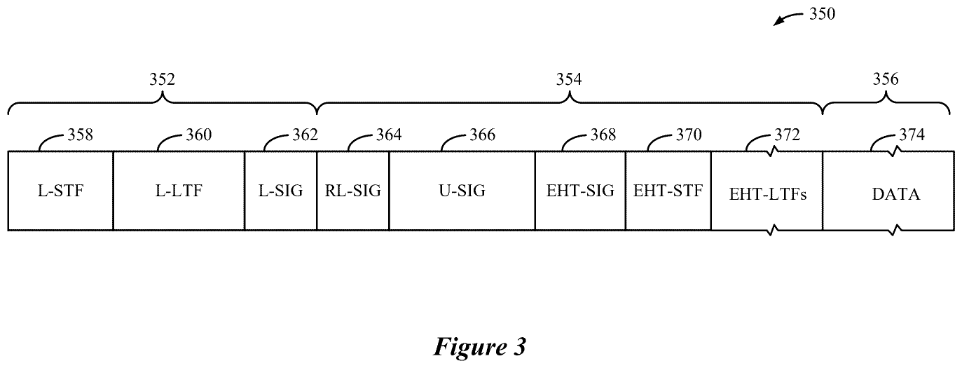

FIG. 3 shows an example PPDU 350 usable for wireless communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field (referred to herein as “U-SIG 366”) and an EHT signal field (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted via each of the component 20 MHz channels in instances involving the use of a bonded channel.

The non-legacy portion 354 further includes an additional short training field (referred to herein as “EHT-STF 370,” although it may be structured as, and carry version-dependent information for, other wireless communication protocol versions beyond EHT) and one or more additional long training fields (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink or downlink resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the quantity of users in allocations, among other examples. The user-specific fields are assigned to particular STAs 104 and carry STA-specific scheduling information such as user-specific modulation and coding scheme (MCS) values and user-specific RU allocation information. Such information enables the respective STAs 104 to identify and decode corresponding RUs in the associated data field 374.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals, such as the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames via the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some implementations of such TDMA techniques, each portion of a set of multiple portions of the TXOP includes a set of time resources that do not overlap with any time resources of any other portion of the set of multiple portions of the TXOP. In such implementations, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other implementations, the sharing AP may directly measure potential interference of a service supported (such as uplink transmission) at one or more APs and select the shared APs in accordance with the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the quantity N_{Tx} of transmit antennas exceeds the quantity N_{SS} of spatial streams. The N_{SS} spatial streams may be mapped to a quantity N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a quantity N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal using each of its antennas to perform beamforming. For example, the steering matrix may be indicative of a phase shift, or a power level, to use to transmit a respective signal using each of the beamformer's antennas.

In some implementations, multiple APs 102 may concurrently transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit concurrently while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all use a copy of the data to be transmitted to the STA 104. Accordingly, the APs 102 may exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in an MU PPDU, use of the MU PPDU format may indicate preamble puncturing for SU transmissions. While puncturing in the IEEE 802.11ax standard amendment is limited to OFDMA transmissions, the IEEE 802.11be standard amendment extends puncturing to SU transmissions. In some implementations, the RU allocation information in the common field of EHT-SIG can be used to individually allocate RUs to the single user, thereby avoiding the punctured channels. In some other implementations, U-SIG may be used to indicate SU preamble puncturing. For example, the SU preamble puncturing may be indicated by a value of the EHT-SIG compression field in U-SIG.

Some APs and STAs, such as, for example, the AP 102 and STAs 104 described with reference to FIG. 1, are capable of MLO. For example, the AP 102 and STAs 104 may support MLO as defined in one or both of the IEEE 802.11be and 802.11bn standard amendments. An MLO-capable device may be referred to as an MLD. In some implementations, MLO supports establishing multiple different communication links (such as a first link on the 2.4 GHz band, a second link on the 5 GHz band, and a third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate via a respective communication link with a respective one or multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some implementations, the exchange of information may occur via a beacon frame, a probe request frame, a probe response frame, an association request frame, an association response frame, another management frame, a dedicated action frame, or an operating mode indicator (OMI), among other examples. In some implementations, an AP MLD may designate a specific channel of one link in one of the bands as an anchor channel via which it transmits beacons and other control or management frames periodically. In such implementations, the AP MLD also may transmit shorter beacons (such as ones which may contain less information) on other links for discovery or other purposes.

MLDs may exchange packets via one or more of the communications links dynamically and, in some instances, concurrently. MLDs also may independently contend for access on each of the communication links, which achieves latency reduction by enabling the MLD to transmit its packets via the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some implementations be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may concurrently transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some implementations, the parallel communication links may support synchronized transmissions. In some other implementations, or during some other durations of time, transmissions via the communication links may be parallel, but not be synchronized or concurrent. Additionally, in some implementations or durations of time, two or more of the communication links may be used for communications between MLDs in the same direction (such as all uplink or all downlink), while in some other implementations or durations of time, two or more of the communication links may be used for communications in different directions (for example, one or more communication links may support uplink communications and one or more communication links may support downlink communications). In such implementations, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated via a first communication link while the traffic associated with the video stream may be communicated via a second communication link in parallel (such that at least some of the data may be transmitted via the first channel concurrently with data transmitted via the second channel). In some other implementations, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and quality of service (QoS) characterization, which may achieve latency reduction and other QoS enhancements by mapping traffic flows having different latency or other requirements to different links. For example, traffic with relatively low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the downlink direction or the uplink direction or both directions to one or more communication links set up between them. In some implementations, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some implementations, an MLD may include multiple radios, and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity via a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving via one of the eMLMR links.

Other MLDs may have more limited capabilities and may not include multiple radios. An MLD with only a single radio that is shared for multiple communication links may be referred to as a multi-link single radio (MLSR) MLD. Control frames may be exchanged between MLDs before initiating data or management frame exchanges between the MLDs in examples in which at least one of the MLDs is operating as an MLSR MLD. Because an MLD operating in the MLSR mode is limited to a single radio, it cannot use multiple communication links concurrently and may instead listen to (for example, monitor), transmit, or receive via only a single communication link at any given time. An MLSR MLD may instead switch between different bands in a time division multiplexing (TDM) manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive via only one of the links at any given time, it may be able to dynamically switch between bands, resulting in improvements in both latency and throughput. For example, when the STAs of a non-AP MLD may detect a BSRP frame via their respective communication links, the non-AP MLD may tune all of its antennas to the communication link via which the BSRP frame is detected. By contrast, a non-AP MLD operating in the MLSR mode can only listen to, and transmit or receive via, one communication link at any given time.

An MLD that is capable of concurrent transmission and reception via multiple communication links may be referred to as a simultaneous transmission and reception (STR) device. In an STR-capable MLD, a radio associated with a communication link can independently transmit or receive frames via that communication link without interfering with, or without being interfered with by, the operation of another radio associated with another communication link of the MLD. For example, an MLD with a suitable filter may simultaneously transmit via a 2.4 GHz band and receive via a 5 GHz band, or vice versa, or simultaneously transmit via the 5 GHz band and receive via a 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception via multiple communication links may be referred to as a non-STR (NSTR) device. A radio associated with a given communication link in an NSTR device may experience interference when there is a transmission via another communication link of the NSTR device. For example, an MLD with a standard filter may not be able to simultaneously transmit via a 5 GHz band and receive via a 6 GHz band, or vice versa, and as such, may be considered an NSTR device for those two communication links.

In some wireless communication systems, an MLD may include multiple non-collocated entities. For example, an AP MLD may include non-collocated AP devices and a STA MLD may include non-collocated STA devices. If an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without performing reassociation) between the APs associated with the SMD entity. The SMD entity also may maintain other context (such as security and Block Acknowledgment (BA)) for non-AP STAs associated with it.

The aforementioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities for a single BSS. For example, MLA may increase the quantity of users per multiplexed transmission served by the multi-link AP MLD.

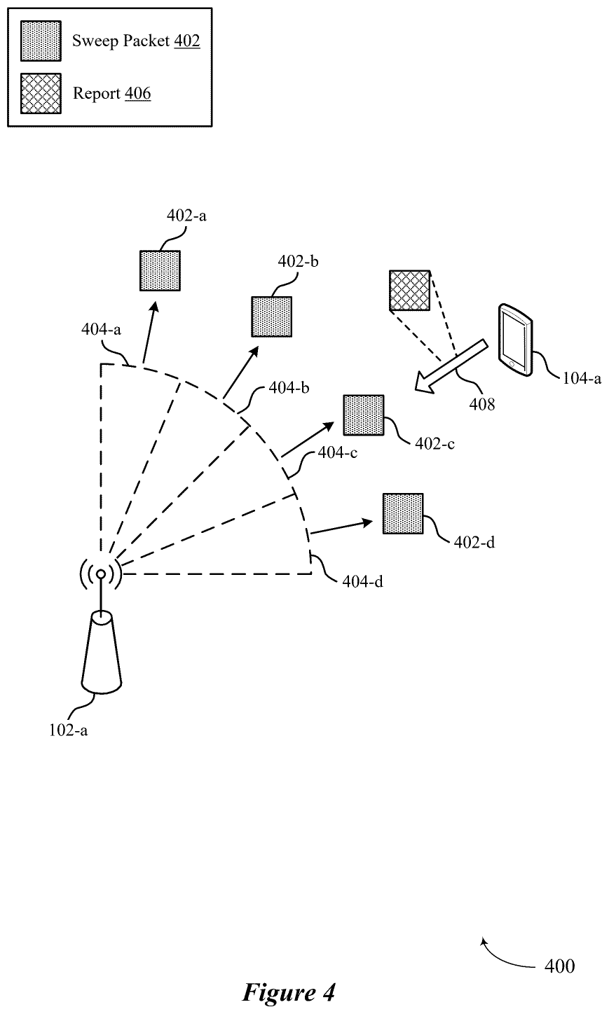

FIG. 4 shows an example of a signaling diagram that supports techniques for IMMW beam training for MLO. The signaling diagram may include a wireless communications system 400 including an AP 102-a and a STA 104-a, which may be examples of an AP 102 and a STA 104, respectively, as described with reference to FIG. 1. The AP 102-a may be an example or a component of an AP MLD, and the STA 104-a may be an example or a component of a non-AP MLD (such as a STA MLD). The wireless communications system 400 may support operations via a 60 GHz frequency band. The AP 102-a and the STA 104-a may use multi-link operation to manage beam training for the 60 GHz frequency band.

The 60 GHz frequency band may provide a relatively large swath of the frequency spectrum for communications. Accordingly, the 60 GHz frequency band may support a relatively large quantity of wireless communication devices and transmissions via the frequency band. However, signal propagation in the 60 GHz frequency band may suffer from relatively high attenuation loss. To mitigate the attenuation loss, the wireless communication devices may perform directional communications using beamformed transmission and reception. The wireless communication devices may perform beam training to align the directions of communication beams for reliable communications. Beam training may involve the wireless communication devices performing beam sweeping procedures to select beams oriented towards other wireless communication devices. For example, the AP 102-a may perform a beam sweeping procedure to select a transmit beam and a receive beam for communicating directional communications with the STA 104-a, and the STA 104-a may perform a beam sweeping procedure to select a transmit beam and a receive beam for communicating directional communications with the AP 102-a.

In some other systems, beam training procedures for the 60 GHz frequency band may involve a relatively high overhead (such as a processing overhead, a signaling overhead, and a beam training latency). For example, a beam training procedure may involve four beam sweeps, including a transmit sector sweep at an initiator device, the transmit sector sweep at a responder device, a receive sector sweep at the initiator device, and the receive sector sweep at the responder device. The devices may take turns performing transmit sector sweeps followed by receive sector sweeps. The quantity of sweeps, as well as the size of sweep packets, may result in significant overhead and latency associated with these beam training procedures.

The wireless communications system 400 may leverage multi-link operations to improve the overhead associated with beam training procedures for the 60 GHz frequency band. For example, the AP 102-a may use another frequency band (such as the sub7 frequency band or another frequency band) to communicate, with the STA 104-a, timing information relating to beam training procedures for the 60 GHz frequency band. The AP 102-a may transmit, via a sub7 link 408 (or another similar active, or otherwise established, link between the AP 102-a and the STA 104-a), a TSF value associated with the AP 102-a, such as associated with a 60 GHz link of the AP 102-a, to the STA 104-a. In some implementations, this TSF value may be an example of a current TSF value advertised (such as via the 60 GHz link or the sub7 link 408) by the AP 102-a, a TSF value indicating a time at which a sector sweep will occur via the 60 GHz link, or both (such as multiple TSF values indicating both a current time and a sector sweep timing). The TSF value may be an example of a full TSF value, such as an eight octet value indicating the TSF value, or a partial TSF value, such as a (lower) two octet value indicating the TSF value. For example, the TSF value may include any quantity of bits or octets that indicate a timestamp, where relatively fewer bits may reduce a packet size for transmission of the TSF value indication. The AP 102-a may indicate the TSF value associated with the 60 GHz link directly or with respect to timing for the sub7 link 408. Alternatively, the AP 102-a and the STA 104-a may use a different timing indicator than a TSF value, such as any timestamp, time offset value, or any other timing information that supports timing synchronization. For example, as used herein, a “TSF value” may refer to any value that indicates a specific time or time offset.

The STA 104-a and the AP 102-a may use the TSF value to coordinate beam training procedures. For example, the STA 104-a and the AP 102-a may coordinate timing for sweep packet transmissions using the TSF value. The AP 102-a may transmit, via the 60 GHz frequency band or link, sweep packets 402 of a beam sweeping procedure at specific TSF values. In some implementations, the AP 102-a may configure the specific TSF values such that the STA 104-a may determine (such as calculate, identify, detect, select, or otherwise ascertain) the specific TSF values and may monitor the 60 GHz frequency band at the specific times for the sweep packets 402. In some other implementations, the AP 102-a may select (such as determine, identify, or otherwise ascertain) the specific TSF values for the sweep packets 402 independent of, or otherwise transparent to, the STA 104-a (such that the STA 104-a is unaware of the specific TSF values corresponding to the sweep packets 402). The AP 102-a may transmit a first sweep packet 402-a corresponding to a first sector 404-a and, accordingly, a first transmit beam for directional communications at a first TSF value. The AP 102-a may transmit a second sweep packet 402-b corresponding to a second sector 404-b at a second TSF value, a third sweep packet 402-c corresponding to a third sector 404-c at a third TSF value, and a fourth sweep packet 402-d corresponding to a fourth sector 404-d at a fourth TSF value. The STA 104-a may monitor the 60 GHz frequency band (such as during a time window that includes the TSF values) and may select a received sweep packet 402 (such as a sweep packet 402 with a strongest receive power, a highest receive quality, or both). The beam sweeping procedure may involve the STA 104-a performing received signal strength measurements with respect to one or more beam directions for directional communications. For example, the STA 104-a may receive the third sweep packet 402-c at the third TSF value (or at a reception time corresponding to transmission at the third TSF value). The STA 104-a may transmit, to the AP 102-a, a report 406 indicating the third TSF value for the received sweep packet 402-c, for example, in accordance with the received signal strength measurements. In some implementations, the STA 104-a may determine (such as calculate, select, identify, detect, or otherwise ascertain) the third TSF value according to a fixed reference time, such as the TSF value advertised by the AP 102-a. The STA 104-a may transmit the report 406 via the sub7 link 408 to the AP 102-a. The AP 102-a may receive the report 406 and, in accordance with the third indicated TSF value, may select a third transmit beam corresponding to the third sector 404-c for communications with the STA 104-a via the 60 GHz band.

Using the techniques described herein, the AP 102-a, such as an AP MLD, and the STA 104-a, such as a non-AP MLD, may support sweep packet overhead reduction, sub7 link-based feedback, AP transmit sector sweep aggregation for multiple STAs 104, sub7 feedback aggregation or piggybacking, timely delivery of training feedback, or any combination thereof for 60 GHz beam training operations.

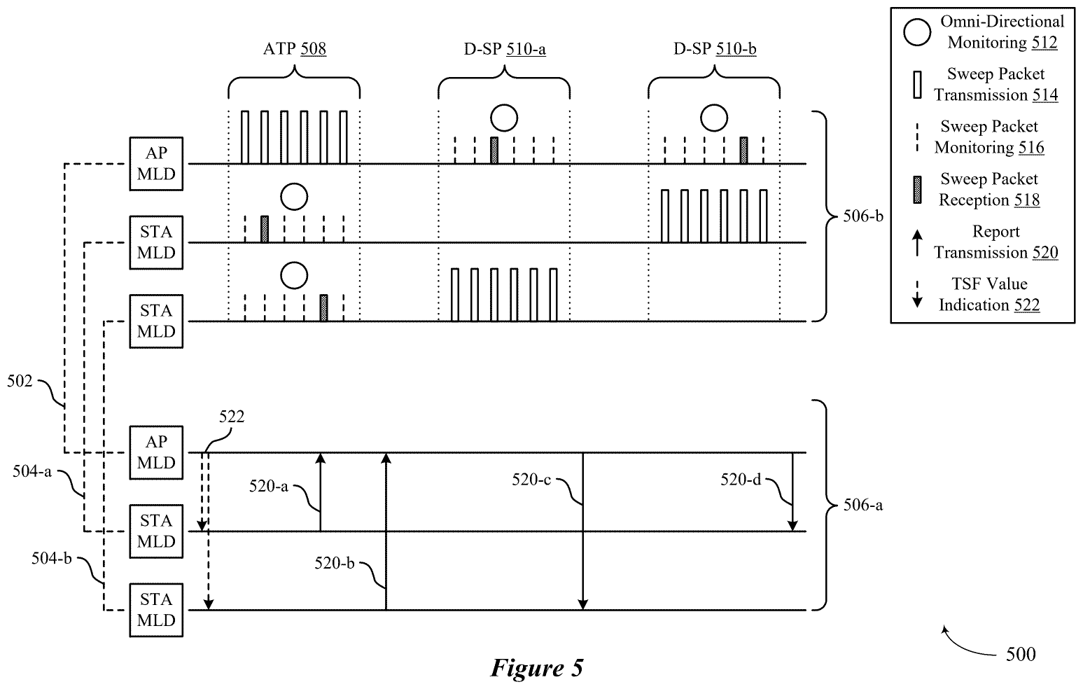

FIG. 5 shows an example of a signaling timeline 500 that supports IMMW beam training for MLO. The signaling timeline 500 may involve an AP MLD 502, a first non-AP MLD 504-a (such as a first STA MLD), and a second non-AP MLD 504-b (such as a second STA MLD). The AP MLD 502 may support a first link via a first frequency band 506-a and a second link via a second frequency band 506-b. For example, the first AP link may be an example of a sub7 link and the second AP link may be an example of a 60 GHz link. Similarly, the first non-AP MLD 504-a may support a first link via the first frequency band 506-a and a second link via the second frequency band 506-b, and the second non-AP MLD 504-b may support a first link via the first frequency band 506-a and a second link via the second frequency band 506-b. The MLDs may leverage the multi-link operation to improve the overhead and latency associated with beam sweeping procedures for the second frequency band 506-b (such as the 60 GHz frequency band supporting directional communications).

In some implementations, the MLDs may support sweep packet overhead reduction using short sweep signals. The MLDs may operate in a non-standalone (NSA) mode, such that an MLD may pair a 60 GHz link with a partner link via the sub7 frequency band 506-a. Using a multi-link operation framework, an MLD may perform management-level signaling for the 60 GHz link via one or more sub7 links. For example, the MLDs may perform discovery, multi-link setup, other agreements (such as BA and timing coordination agreements), or any combination thereof via the sub7 link. The non-AP MLDs may determine (such as receive, select, or otherwise ascertain) information relating to a 60 GHz link, include the 60 GHz link as part of a multi-link set, set up service periods for the 60 GHz link, or any combination thereof using communications via the sub7 link, for example, without exchanging frames via the 60 GHz link. As such, the MLDs may use omni- or quasi omni-directional (such as non-directional) communications via the sub7 link to support beamforming operations for the partnered 60 GHz link. Although described herein with reference to a sub7 link and a 60 GHz link, the techniques described herein may apply to other types of links associated with other frequency bands.

The multi-link operation framework may involve the AP MLD 502 maintaining constant TSF offsets for each link (such as each affiliated AP) associated with the AP MLD 502. In some implementations, the AP MLD 502 may advertise one or more TSF offsets, where a TSF offset is for a first AP link with respect to another affiliated AP link. For example, the AP MLD 502 may transmit an advertisement packet or another packet including a TSF value indication 522 associated with a link of the AP MLD 502, such as a second link associated with the 60 GHz frequency band 506-b. In some implementations, the packet may include a TSF offset field or subfield indicating an offset between a TSF timer of a first AP of the AP MLD 502 and a TSF timer of a second AP of the AP MLD 502, where the offset may be an example of a TSF value indication 522. The AP MLD 502 may transmit the TSF value indication 522 via the first link using an omni- or quasi omni-directional transmission. One or more non-AP MLDs, such as the non-AP MLD 504-a, may receive the packet and may determine (such as receive, decode, process, or otherwise ascertain) the TSF for at least one link of the AP MLD 502. Using the constant TSF offset information, the non-AP MLD 504-a may use the received TSF value for any one link of the AP MLD 502 to determine (such as calculate, select, or otherwise ascertain) the TSF for any other link of the AP MLD 502 in accordance with a TSF offset.

The AP MLD 502 may negotiate or indicate timing information with the non-AP MLD 504-a via the sub7 link to support beam training procedures for the 60 GHz link. For example, the AP MLD 502 may indicate to the non-AP MLD 504-a an exact time, such as an exact TSF value, for beam training. This time can be common to more than one non-AP MLD or can be reserved for a specific non-AP MLD. For example, a common start time for multiple non-AP MLDs to perform beam training may be an example of a start time for an AP sector reference transmit period (ATP). During the ATP, the AP MLD 502 may perform a common beam sweep for multiple non-AP MLDs. The AP MLD 502 may configure a start time for a beam sweeping procedure via the 60 GHz frequency band, a dedicated time period for beam training, or both using the TSF information. For example, the AP MLD 502 and the non-AP MLD 504-a may establish a devoted service period for performing beam sweeping. In some systems, the dedicated time periods may be set up to repeat at relatively frequent intervals (for a relatively long period of time) such that the dedicated periods may be used for exchanging data frames between the AP MLD 502 and the non-AP MLD 504-a after the beam training procedure commences (and directional beams between the AP MLD 502 and the non-AP MLD 504-a have been established). The relatively highly directional nature of the 60 GHz frequency band may support the MLDs gaining access to the 60 GHz medium for the devoted service period to perform directional sweep packet transmissions 514.

Because both MLDs are configured with the specific timing information for the beam training procedures, the MLDs may refrain from using training sequences, sector identification information, or both in the sweep packets to support sweep packet identification. Refraining from using the training sequences, sector identification information, or both may reduce the overhead associated with the sweep packet transmissions 514, improving the latency and overhead of the beam sweeping procedures. Such sweep packets may be referred to as “short” sweep packets. A short sweep packet may span one or two microseconds with a physical design including an LTF, which may span approximately one microsecond, or an LTF and a SIG, which may span approximately two microseconds. The short sweep packet may include a fixed pattern of bits or tones which a receiving MLD may use to differentiate the short sweep packet from ambient or surrounding noise. In some implementations, the AP MLD 502 may configure the fixed pattern for the sweep packets during association procedures (such as via the sub7 link). The fixed pattern may be unique to the AP MLD 502. In some other implementations, the non-AP MLD 504-a may be configured with a fixed pattern for the short sweep packets. For example, the fixed pattern may be defined in a wireless Standard, such as one or more IEEE 802.11 standards. In some implementations, the short sweep packet may include sector identification information (such as a sector identifier), a device identifier (such as an AP identifier or a non-AP STA identifier indicating the device that transmits the short sweep packet or a BSS color indicating the AP that transmits the short sweep packet), the fixed pattern of bits or tones, or any combination of these elements. Such elements may support identification of the short sweep packet.

Instead of using a training sequence or sector identification information to identify which sweep packet transmission 514 is received, an MLD receiving a sweep packet transmission 514 may identify the sweep packet using the time (for example, corresponding to a TSF value) at which the sweep packet is received. In accordance with the TSF coordination between links, the MLD that receives one or more sweep packets may select and report the TSF value for the sweep packet satisfying a threshold. For example, the MLD may select and report the TSF value for a sweep packet corresponding to a strongest received signal power, satisfying a quality threshold, or some combination thereof. The MLD that transmitted the sweep packets may receive the transmitted report 520 and may correlate the indicated TSF value with corresponding sector information to support transmit beam selection.

For example, the AP MLD 502 may transmit, via the first link, a TSF value indication 522 associated with a second link of the AP MLD 502 to a non-AP MLD 504-a. The AP MLD 502 may additionally configure a time period for performing a transmit beam sweep in accordance with the indicated TSF value. The AP MLD 502 may transmit, via the second link, a set of sweep packet transmissions 514 during the configured time period, and the non-AP MLD 504-a may perform omni- or quasi omni-directional monitoring 512 during the configured time period. For example, the non-AP MLD 504-a may monitor the second frequency band 506-b for the sweep packet transmissions 514 during the configured time period in accordance with the indicated TSF value and the fixed pattern for the sweep packets. The non-AP MLD 504-a may detect, or otherwise receive, one or more of the sweep packet transmissions 514 in accordance with the sweep packet monitoring 516. If the non-AP MLD 504-a receives one sweep packet transmission 514, the non-AP MLD 504-a may determine (such as receive, decode, process, or otherwise ascertain) the TSF value for the sweep packet reception 518. If the non-AP MLD 504-a receives more than one sweep packet transmission 514, the non-AP MLD 504-a may determine (such as calculate, select, or otherwise ascertain) the TSF value for the sweep packet reception 518 that satisfies a threshold, such as a signal strength or signal quality threshold. The non-AP MLD 504-a may transmit a report 520-a via the first link indicating the determined TSF value or another value that corresponds to the determined TSF value, such as a packet identifier or a beam identifier. The non-AP MLD 504-a may receive the report 520-a and may select a transmit beam to use for the second link that corresponds to the reported value, such as the reported TSF value. Additionally, or alternatively, the non-AP MLD 504-a may perform similar beam training to select a transmit beam to use for the second link.

In some implementations, a non-AP MLD 504-a may trigger beam training for a 60 GHz link in accordance with one or more factors. If the non-AP MLD 504-a newly associates with the AP MLD 502 for a 60 GHz link, the non-AP MLD 504-a may perform beam training with the affiliated AP for the 60 GHz band prior to initiating frame exchanges via the 60 GHz link. The non-AP MLD 504-a may perform discovery, multi-link setup, or both via the sub7 frequency band using multi-link operation framework. Additionally, or alternatively, if a non-AP MLD 504-a is inactive for at least a threshold amount of time via the 60 GHz link, the non-AP MLD 504-a may perform beam training with the affiliated AP for the 60 GHz band to update beam selection if the orientation of the non-AP MLD 504-a to the AP MLD 502 has changed during the period of inactivity. Additionally, or alternatively, a non-AP MLD 504-a that is active via the 60 GHz link may trigger beam training if the non-AP MLD 504-a detects beam misalignment with the AP MLD 502. In some implementations, the affiliated AP for the 60 GHz band may transmit a reference signal or another packet via the 60 GHz link that indicates to the non-AP MLD 504-a whether any beam misalignment has occurred. In some other implementations, the AP MLD 502 may determine (such as identify, calculate, or otherwise detect) beam misalignment with the non-AP MLD 504-a and may transmit, to the non-AP MLD 504-a, an indication to trigger beam training. The non-AP MLD 504-a may perform beam training or refinement if beam misalignment is detected.

In some implementations, the AP MLD 502 may perform a beam sweep procedure for the 60 GHz frequency band during one or more common periods. For example, the affiliated AP for the 60 GHz band may perform a transmit beam sweep during the one or more common periods. The AP MLD 502 may advertise information about the one or more common periods via the sub7 link. One or more non-AP MLDs may monitor the 60 GHz band during the common period to derive relevant beam training information. For example, during a same common period, an active non-AP MLD 504-a may determine (such as identify or select) to retrain or refine beam alignment, while a newly associated or newly active non-AP MLD 504-b may perform beam training using the same sweep packet transmissions 514, effectively aggregating the AP MLD's transmit sweep for multiple non-AP MLDs. Accordingly, any quantity of non-AP MLDs may monitor the second frequency band 506-b during the common period and may receive the same or different sweep packet transmissions 514 in accordance with the monitoring. In some implementations, the common period may be referred to as a transmit period, an ATP, or any similar terminology. The ATP 508 duration may be relatively short (such as one microsecond per AP sector). For example, both the first non-AP MLD 504-a and the second non-AP MLD 504-b may perform omni- or quasi omni-directional monitoring 512 during the ATP 508 and may receive different sweep packet transmissions 514 during the ATP 508 in accordance with the different directions between the AP MLD 502 and the different non-AP MLDs. In some implementations, a sweep packet transmission 514 during the ATP 508 may be an example of an AP sector reference (ASR) frame transmission. The ASR frame may be an example of, or similar to, a relatively short beacon or beacon frame. The ASR frame may include a subset of information as compared to a beacon frame, such as partial TSF information, a sector identifier, a short identifier of a transmitting device (such as a transmitting AP), or any combination thereof. The first non-AP MLD 504-a may transmit a first report 520-a indicating a first TSF value for sweep packet reception 518 at the first non-AP MLD 504-a, and the second non-AP MLD 504-b may transmit a second report 520-b indicating a second TSF value for sweep packet reception 518 at the second non-AP MLD 504-b.

In some implementations, the AP MLD 502 may split its transmit beam sweep across multiple ATPs 508. For example, the AP MLD 502 may perform a partial beam sweep during an ATP 508. In some implementations, the AP MLD 502 may transmit sweep packets associated with respective transmit beams corresponding to a first subset of sectors of the AP MLD 502 during the ATP 508, and the AP MLD 502 may transmit sweep packets associated with respective transmit beams corresponding to a second subset of sectors of the AP MLD 502 different from the first subset of sectors during a subsequent ATP 508. If the beam sweep during an ATP 508 does not cover the sector corresponding to a non-AP MLD, the non-AP MLD may fail to detect a sweep packet transmission 514 from the AP MLD 502 during the ATP 508. The non-AP MLD may refrain from reporting a TSF value if the non-AP MLD fails to detect a sweep packet while monitoring during the ATP 508. For example, if the non-AP MLD supports trigger-based (TB) reporting, the non-AP MLD may respond to a trigger frame (TF) with a null, or otherwise empty (such as a 0 value), report.

In some implementations, the AP MLD 502 may configure devoted, or dedicated, time periods for the non-AP MLDs to perform transmit beam sweeps. For example, the AP MLD 502 may establish a first dedicated time period for the first non-AP MLD 504-a to perform a transmit beam sweep via the 60 GHz frequency band and may establish a second dedicated time period for the second non-AP MLD 504-b to perform a transmit beam sweep via the 60 GHz frequency band. The devoted, or dedicated, time period may be referred to as a devoted sweep period (D-SP) or other similar terminology. The D-SP duration may span several milliseconds. In some implementations, the AP MLD 502 may set up a D-SP for the non-AP MLD 504-a via sub7 signaling, for example, using an AP coordination interval framework (such as a target wake time (TWT) framework). For example, the AP MLD 502 may configure, via one or more sub7 links, a first D-SP 510-a for the non-AP MLD 504-b and a second D-SP 510-b for the non-AP MLD 504-a. In some implementations, a non-AP MLD may use a configured D-SP for data exchange via the 60 GHz band after completion of the beam training procedures for the 60 GHz band.

During the first D-SP 510-a, the non-AP MLD 504-b may perform sectorized sweep packet transmissions 514 via the 60 GHz band, and the AP MLD 502 may monitor the 60 GHz band for the sweep packet transmissions 514. The AP MLD 502 may use omni- or quasi omni-directional monitoring or may monitor according to a direction selected for a transmit beam in accordance with the AP MLD's transmit beam sweep. If the AP MLD 502 detects, or otherwise receives, one or more sweep packet transmissions 514 from the non-AP MLD 504-b, the AP MLD 502 may transmit a report 520-c indicating a TSF value corresponding to a sweep packet reception 518. The AP MLD 502 may transmit the report 520-c to the non-AP MLD 504-b via the sub7 link.

Additionally, or alternatively, during the second D-SP 510-b, the non-AP MLD 504-a may perform sectorized sweep packet transmissions 514 via the 60 GHz band, and the AP MLD 502 may monitor the 60 GHz band for the sweep packet transmissions 514. If the AP MLD 502 detects, or otherwise receives, one or more sweep packet transmissions 514 from the non-AP MLD 504-a, the AP MLD 502 may transmit a report 520-d indicating a TSF value corresponding to a sweep packet reception 518. The AP MLD 502 may transmit the report 520-d to the non-AP MLD 504-a via the sub7 link.

In some implementations, the AP MLD 502 may repeatedly advertise timing information to support drift correction. For example, the AP MLD 502 may provide local time information at periodic (or semi-periodic, or otherwise scheduled) intervals. The AP MLD 502 may transmit a frame including timing information, such as updated TSF values for one or more APs of the AP MLD 502. In some implementations, the AP MLD 502 may transmit the frame according to a frequency or periodicity, such as every 20 milliseconds. The frame may be an example of a fast initial link setup (FILS) discovery (FD) frame, broadcast probe response frame, or some other broadcast or individually addressed frame. The timing information may have a relatively high granularity (such as a few nanoseconds). For example, the granularity of the timing information may refer to a periodicity (or frequency) at which the timing information is advertised or otherwise indicated. In some implementations, the field of the frame including the timing information may include a full TSF value or a partial TSF value, such as one or more least significant bits (LSBs) of the TSF value. In some systems, the field carrying the timing information may be integrity protected (such as by generating a message integrity check (MIC)) or protected via encryption.

In some systems, the AP MLD 502 may indicate a start of a training period (ATP or devoted) with a relatively low granularity (such as using units of 1 microsecond). For example, the granularity of the start time may refer to a periodicity (or frequency) at which the start time is indicated. Accordingly, in some implementations, the start of the training period may appear to be, to the AP or the non-AP, off by up to 1 microsecond. In some such implementations, the devices may start their transmit sweeps a little late (such as up to 1 microsecond late) to account for this difference in interpretation of the start time of the beam training period.

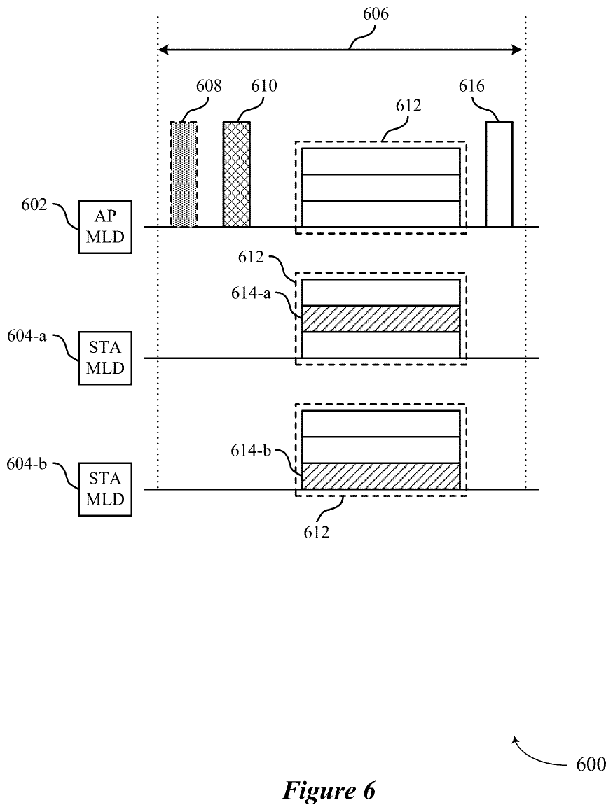

FIG. 6 shows an example of a reporting format 600 that supports IMMW beam training for MLO. An AP MLD 602, which may be an example of an AP MLD 502 or an AP 102 as described herein with reference to FIGS. 1, 4, and 5, may trigger reporting for beam training feedback from one or more non-AP MLDs. For example, a first non-AP MLD 604-a and a second non-AP MLD 604-b (which may be referred to as STA MLDs) may perform beam training and may report beam training feedback to the AP MLD 602. The non-AP MLDs may be examples of non-AP MLDs or STAs 104 as described herein with reference to FIGS. 1, 4, and 5. The AP MLD 602 may aggregate reporting feedback from the non-AP MLDs to avoid collisions of the reports.

The AP MLD 602 may perform a transmit beam sweep via a 60 GHz frequency band during a common period. Multiple non-AP MLDs may monitor the 60 GHz frequency band during the common period to perform beam training with the AP MLD 602 and may report feedback via a sub7 frequency band, such as indicating a TSF value for a received sweep packet during the beam sweep. To avoid collisions between the feedback for the multiple non-AP MLDs, the AP MLD 602 may trigger one or more non-AP MLDs to provide aggregated feedback. For example, the AP MLD 602 may determine (such as detect, identify, select, or otherwise ascertain) non-AP MLDs that relatively recently performed multi-link setup including a 60 GHz link, non-AP MLDs that relatively recently transitioned to an active mode for a 60 GHz link, or both.

The AP MLD 602 may transmit a TF 610 indicating one or more RUs for the non-AP MLDs to provide beam training feedback. In some implementations, the TF 610 may indicate directed RUs for specific non-AP MLDs to report beam training feedback. Additionally, or alternatively, the TF 610 may indicate random access (RA) RUs for non-AP MLDs to report beam training feedback. Any non-AP STA, such as a non-AP STA not receiving a directed RU, may use an RA-RU to provide feedback. In some implementations, the TF 610 may include a special AID for the RA-RUs to avoid receiving a response from other non-IMMW or non-training STAs.

The TF 610 may trigger a TB PPDU 612 which may include feedback from multiple non-AP MLDs. For example, the TB PPDU 612 may include one or more directed RUs for specific non-AP MLDs, one or more RA-RUs for any non-AP MLDs, or a combination thereof. In some implementations, the AP MLD 602 may determine (such as identify or otherwise detect) that a first non-AP MLD 604-a is in a training mode but may fail to determine (such as fail to identify or otherwise detect) that a second non-AP MLD 604-b is in the training mode. The AP MLD 602, via the TF 610, may assign a directed RU, such as a first RU 614-a, for the first non-AP MLD 604-a and may not assign a directed RU for the second non-AP MLD 604-b. Instead, the second non-AP MLD 604-b may use an RA-RU, such as a second RU 614-b, indicated by the TF 610 as an RA-RU for beam training feedback. The first non-AP MLD 604-a may report a first TSF value via the first RU 614-a and the second non-AP MLD 604-b may report a second TSF value via the second RU 614-b of the TB PPDU 612. For example, the first non-AP MLD 604-a may report the first TSF value via the first RU 614-a in a frame, such as an extension of a multi-STA BA frame, a QoS Null frame, a QoS Data frame, an action frame (such as a new action frame), an extension to a management frame, or any combination of these or other frames.

In some implementations, the AP MLD 602 may transmit a first frame 608 prior to the TF 610 (such as a basic TF) to determine (such as identify, detect, or otherwise ascertain) which non-AP MLDs are in the training mode for beam training via the 60 GHz band. For example, the first frame 608 may be an example of a short feedback report poll, a variant of an NDP feedback report poll (NFRP), a variant of a BSRP, or some combination thereof polling for beam training feedback. In some implementations, the short feedback report poll may request responses from non-AP MLDs that performed beam training during a common period for AP transmit beam sweeping. Non-AP MLDs may respond to the first frame 608 if the non-AP MLDs are in the training mode, monitored the 60 GHz band during an AP transmit beam sweeping procedure, or received a sweep packet. The AP MLD 602 may assign directed RUs, via the TF 610, for non-AP MLDs that respond to the first frame 608 to reduce the likelihood of RA-RU collisions by different non-AP MLDs. The non-AP MLDs may report beam training feedback, such as TSF values, via the directed RUs of the TB PPDU 612. In some implementations, the AP MLD 602 may transmit, via the sub7 frequency band, a multi-STA BA 616 to the non-AP MLDs reporting TSF values via the TB PPDU 612 acknowledging receipt of the reports.

The non-AP MLDs may report the beam training feedback in a relatively timely manner, such as within a threshold time. However, transmissions via the sub7 frequency band may be contention-based, causing the actual transmit times for the reports to vary. In some implementations, the AP MLD 602 may set up a protected period for receiving the reports via the sub7 frequency band. For example, to ensure timely delivery of the beam training feedback, the AP MLD 602 may announce one or more special channel access periods 606 for protecting a feedback duration from other transmissions, such as in-BSS transmissions. Other MLDs may refrain from contending for the sub7 band (or a portion of the sub7 band) during the special channel access periods 606. In some implementations, neighboring APs may coordinate the special channel access periods 606 to protect the timely delivery of the beam training feedback. In some implementations, the AP MLD 602 may support a special channel access period 606 using an inter-AP coordination interval or epoch, an inter-AP service interval or epoch, an AP coordination interval or epoch, or any other techniques for configuring a service period (such as (coordinated) restricted TWT ((c)rTWT)). For example, the AP MLD 602 may advertise or negotiate the special channel access period 606. In some implementations, crTWT may involve in-BSS STAs that support rTWT and coordinating OBSS APs to refrain from contending via the sub7 band in accordance with the special channel access period 606 start time. The AP MLD 602 may have prioritized channel access for the sub7 frequency band.

In some implementations, the start of the sub7 special channel access period 606 may align with, or near, the end of the 60 GHz ATP, as described herein with reference to FIG. 5. For example, the AP MLD 602 may configure the ATP and the special channel access period 606 to handle reception of the last sweep signal via the 60 GHz band while providing sufficient time to transmit a first frame, such as the frame 608 or the TF 610 soliciting feedback, within the special channel access period 606.

In some implementations, the AP MLD 602 may employ one or more mechanisms for added protection and relatively faster feedback via the sub7 frequency band. For example, the AP MLD 602 may use MU enhanced distributed channel access (EDCA) with an arbitration inter-frame spacing number (AIFSN) set to zero, clear to send (CTS) enablement, relatively shorter TXOPs, or any combination thereof for one or more sub7 links.

Additionally, or alternatively, the AP MLD 602 may aggregate or piggyback beam training feedback reporting to one or more non-AP MLDs to similarly support timely delivery of beam training feedback for a non-AP MLD's transmit beam sweep. For example, the AP MLD 602 may transmit beam training feedback, such as a TSF value for a received sweep packet, to a non-AP MLD, such as the non-AP MLD 604-a, via the sub7 frequency band. The AP MLD 602 may aggregate or piggyback the beam training feedback along with other downlink data from the AP MLD 602 to the non-AP MLD 604-a (or to a different non-AP MLD 604-b). For example, the AP MLD 602 may aggregate the feedback in an A-MPDU if the AP MLD 602 has pending frames for the non-AP MLD 604-a. Additionally, or alternatively, the AP MLD 602 may transmit a downlink MU-PPDU including the beam training feedback for the non-AP MLD 604-a while serving one or more other non-AP MLDs via the sub7 band.

In some implementations, to guard against any clock drift, the AP MLD 602 may transmit an indication of a local time, such as a TSF value for an AP of the AP MLD 602, to one or more non-AP MLDs. For example, the AP MLD 602 may transmit the indication of the local time before polling the non-AP MLDs. The AP MLD 602 may transmit an explicit frame including the time information (which may or may not be aggregated with the short feedback report poll, if present) or the time information may be included with the TF 610 soliciting the beam training feedback. For example, the TF 610 may include a special user information field including a TSF value. A non-AP MLD, such as the non-AP MLD 604-a, receiving the timing information may apply any corrections to the TSF value for reporting prior to transmitting the report, for example, to correct for any clock drift. Additionally, or alternatively, the AP MLD 602 may embed local time information, such as a TSF value, with its report of the TSF corresponding to a received sweep packet from a non-AP MLD. The non-AP MLD may apply any corrections to the indicated TSF value to parse the report from the AP MLD 602.

In some implementations, the AP MLD 602 may use an individually addressed TSF poll to receive beam training feedback from the non-AP MLDs. For example, instead of polling the non-AP MLDs by broadcasting a TF 610 soliciting feedback via the sub7 frequency band after the ATP, the AP MLD 602 may transmit an individually addressed TSF poll frame, which may be similar to an NFRP-type frame, to one or more non-AP MLDs to receive feedback from the non-AP MLDs. For example, the TSF poll frame may be a variant of the NFRP frame or a new short feedback report poll frame (which may be defined by a Standard, such as an IEEE 802.11 standard), where each response tone maps to a beam TSF value. The non-AP MLD 604-a receiving the TSF poll addressed to that non-AP MLD 604-a may set the tone for a response that corresponds to the TSF value for a received sweep packet. In some implementations, the TSF poll frame may additionally include a field that provides a timing reference, such as a TSF value, to account for clock drift. Such a feedback process may relax the timing for the AP MLD 602 polling the non-AP MLDs for TSF values corresponding to transmit beams. The AP MLD 602 may transmit such TSF poll frames to non-AP MLDs that the AP MLD 602 identifies as having recently performed multi-link setup, recently transitioned to an active state for the 60 GHz band, are likely to have monitored the AP MLD's ATP for the 60 GHz band, or any combination thereof. Additionally, or alternatively, the AP MLD 602 may transmit a TSF poll frame, such as an NFRP or short feedback report poll variant, after the ATP via the 60 GHz band to identify which non-AP MLDs are in the beam training phase (such as monitored the 60 GHz band during the ATP) and may poll each of these non-AP MLDs individually.

Additionally, or alternatively, the AP MLD 602 may transmit multiple NFRPs or short feedback report polls via the sub7 band after the ATP, each poll corresponding to a TSF value or a group of TSF values. Such polls may include a field that indicates a corresponding TSF value, and each tone may map to an AID of a non-AP MLD being polled. A responding non-AP MLD may set the tone matching its AID to a specific value if the non-AP MLD selects the TSF value corresponding to the specific poll for reporting. In some implementations, the poll may additionally include a field that provides a timing reference, such as a TSF value, to account for clock drift. In some implementations, the AP MLD 602 may protect such polling and polling response exchanges via crTWT or other coordination techniques.

In some implementations, a non-AP MLD, such as the non-AP MLD 604-a, may transmit a TSF report for beam training via a multi-STA BA frame. The multi-STA BA frame format may be extensible, such that a Standard (such as an IEEE 802.11 standard) may define a mechanism for the multi-STA BA frame to include beam training information, including a TSF value. In some implementations, the AP MLD 602 may transmit a special form of a multi-user BA request (MU-BAR) frame to solicit reports from multiple STAs 104 (such as non-AP MLDs), and the multiple STAs 104 may respond with a multi-STA BA with a modified format to provide respective TSF reports (such as beam training feedback) for the multiple STAs 104. In some other implementations, the multi-STA BAs may be unsolicited, where a STA 104 may transmit its own multi-STA BA including beam training feedback information. Additionally, or alternatively, the AP MLD 602 may use a multi-STA BA frame to provide beam training feedback to multiple STAs 104, such as multiple non-AP MLDs.

In some implementations, the AP MLD 602 may select which feedback scheme to use in accordance with a quantity of sectors of the AP MLD 602, a quantity of non-AP MLDs performing beam training with the AP MLD 602, or some combination thereof. For example, if the AP MLD 602 has a relatively large quantity of sectors, such as 32 or 64, with a relatively small quantity of non-AP MLDs operating in the beam training mode, such as one to twenty non-AP MLDs, the AP MLD 602 may select a feedback scheme involving individual short feedback report polling of the non-AP MLDs.

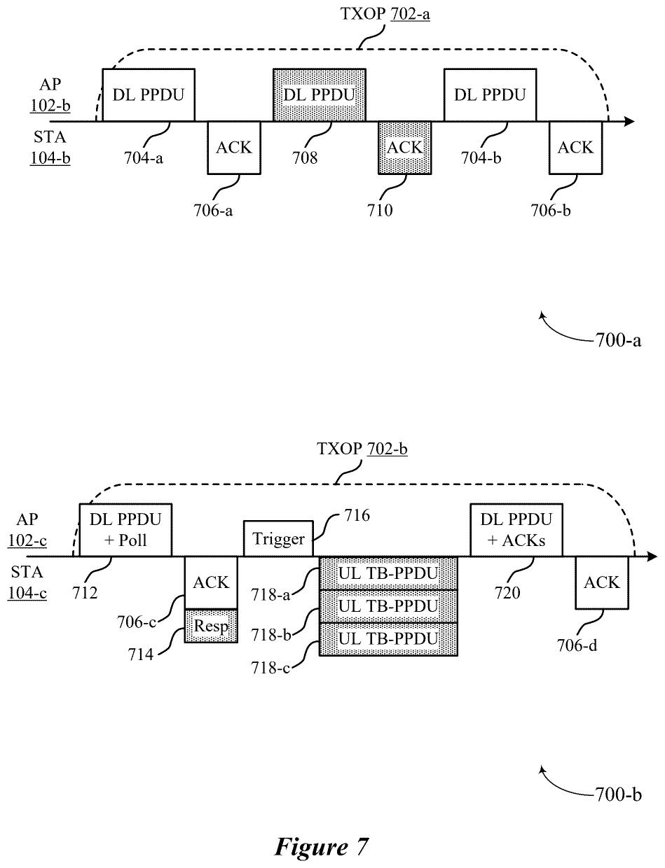

FIG. 7 shows examples of preemption procedures that support IMMW beam training for MLO. The preemption procedures may include an example downlink preemption procedure 700-a and an example uplink preemption procedure 700-b. In some implementations, an AP MLD, such as an AP MLD as described herein with reference to FIGS. 1 and 4-6, may support preemption techniques to facilitate timely delivery of training feedback via a sub7 link.

For example, the AP MLD may preempt an on-going PPDU via the sub7 channel to poll or provide feedback for a transmit beam sweep performed via the 60 GHz band. In some implementations, the AP MLD may refrain from setting up a dedicated time interval (such as a TWT or rTWT) for feedback polling if the preemption scheme is used. After the AP MLD performs a transmit beam sweep, for example, during an ATP via the 60 GHz frequency band, the AP MLD may contend for a TXOP via the sub7 band. If the AP MLD wins contention of the TXOP, the AP MLD may transmit frames to solicit feedback via the sub7 band. However, if a non-AP MLD, such as a STA 104 within the AP MLD's BSS wins contention of the TXOP, the AP MLD may transmit a preemption request to the STA 104 to gain access to the sub7 medium in order to perform polling. In some implementations, the AP MLD may inform STAs 104 when to permit preemption, for example, using configuration or management signaling. In some aspects, preemption may be associated with polling priority. In some implementations, an IMMW STA 104 may detect the ATP via the 60 GHz band and may allow preemption during a sub7 TXOP in accordance with the ATP.

After a non-AP MLD performs a transmit beam sweep via the 60 GHz frequency band, the AP MLD may provide feedback via the sub7 link. In some implementations, the AP MLD may perform preemption-based feedback, where the AP MLD may preempt an in-BSS STA transmission. In some other implementations, the AP MLD may aggregate or piggyback the feedback with an AP's (the same AP 102 or a different AP 102) downlink transmission. Neighboring APs may set up such preemption schemes so that IMMW sub7 APs 102 may preempt the transmissions of other sub7 APs 102 to support feedback polling via the sub7 frequency band.

In some implementations, the AP MLD may support sharing-based TXOP feedback using coordinated-TDMA (c-TDMA) between APs 102. For example, the AP MLD may negotiate c-TDMA such that a neighboring AP that owns a sub7 TXOP may share at least a portion of the TXOP with the AP MLD if the portion of the TXOP approximately aligns with an end time of the AP MLD's ATP via the 60 GHz band.

The AP MLD may support downlink preemption procedures 700-a, uplink preemption procedures 700-b, or both for the sub7 frequency band. For example, a sub7 AP 102 may preempt its transmission to a sub7 STA 104 and allow for transmission to or from a different STA 104. For the downlink preemption procedure 700-a, a sub7 AP 102-b may preempt its own downlink transmission to a STA 104-b to instead perform a relatively higher priority or time sensitive downlink transmission to a different STA 104. For example, the AP 102-b may gain access to the sub7 channel for a TXOP 702-a and may split a long PPDU into multiple relatively shorter PPDUs. The AP 102-b may transmit a first downlink PPDU 704-a to the STA 104-b and may receive an acknowledgment (ACK) message, such as an ACK 706-a, in response. However, the AP 102-b may preempt a subsequent downlink PPDU, for example, to support beam training feedback procedures for a 60 GHz link. The AP 102-b may transmit a preempted downlink PPDU 708 to a different STA 104-b and may receive a preempted ACK 710 from the different STA 104-b. In some implementations, the AP 102-b may continue to transmit a second downlink PPDU 704-b to the STA 104-b and may receive an ACK 706-b in response during the TXOP 702-a.

For the uplink preemption procedure 700-b, a sub7 AP 102-c may preempt its own downlink transmission to a STA 104-c to instead allow the STA 104-c to transmit a relatively higher priority or time sensitive uplink transmission to the AP 102-c. For example, the AP 102-c may gain access to the sub7 channel for a TXOP 702-b and may split a long PPDU into multiple relatively shorter PPDUs. The AP 102-c may transmit a first downlink PPDU with a poll 712, such as including an NFRP or a BSRP, to the STA 104-c and may receive an ACK 706-c and a response 714 to the poll, such as an NDP feedback report (NFR) or buffer status report (BSR). The poll may support uplink preemption of a portion of the TXOP 702-b. The AP 102-c may transmit a TF 716 to trigger the uplink preemption, and the STA 104-c may transmit one or more uplink PPDUs to the AP 102-c. For example, the STA 104-c may transmit a first uplink TB-PPDU 718-a, a second uplink TB-PPDU 718-b, a third uplink TB-PPDU 718-c, or any combination thereof in the preempted resources (such as in response to the TF 716). In some implementations, multiple STAs 104 may transmit uplink TB-PPDUs in the preempted resources. The AP 102-c may transmit a second downlink PPDU with ACKs 720 for the uplink TB-PPDUs, and the STA 104-c may respond with an ACK 706-d. In some implementations, the AP 102-c may support utility-oriented resource allocation (UORA)-based preemption for uplink preemption.

For both uplink and downlink preemption, the sub7 AP may provide some signaling either via a preamble of an initial downlink PPDU or embedded in the frame of a downlink MPDU to support the preemption. The signaling may allow an associated STA 104 to prepare to either transmit or receive a preempted frame. For example, for uplink preemption, the AP 102-b may indicate that it is allowing a STA 104, such as a STA 104 with a beam training TSF value to report, to preempt the AP's downlink resources to send time-sensitive uplink traffic (such as the report). In some implementations, the STA 104 may have an uplink TXOP for transmitting to the AP 102-c. The AP 102-c may acknowledge the STA's uplink transmission and may add a per-AID TID information field that includes beam training information feedback. For downlink preemption, the signaling may allow the AP 102-c to prepare a STA 104, such as a STA 104 that is participating in beam training via the 60 GHz band, to receive the AP's TSF report via the sub7 band. Additionally, or alternatively, preparing for downlink preemption may involve the STA 104 refraining from setting an in-BSS NAV and entering a “doze” state. Additionally, or alternatively, the AP 102 may set a downlink NAV (for example, in an initial downlink PPDU) to a short NAV, such that the corresponding STA 104 is awake and monitoring for any transmissions from the AP 102.

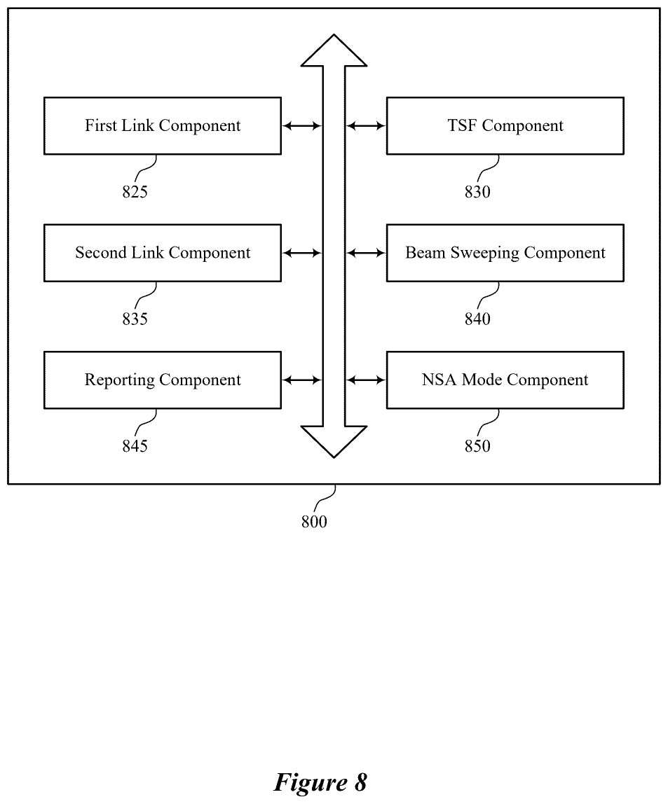

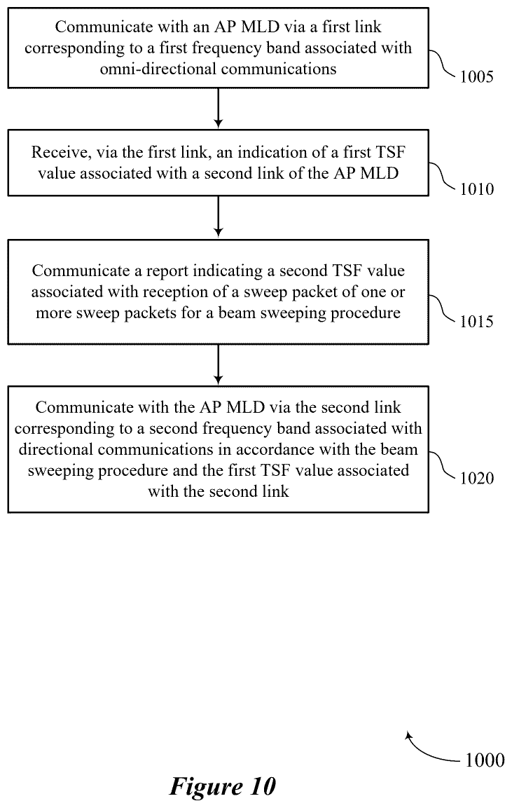

FIG. 8 shows a block diagram of an example wireless communication device 800 that supports IMMW beam training for MLO. In some implementations, the wireless communication device 800 is configured to perform the process 1000 described with reference to FIG. 10. The wireless communication device 800 may include one or more chips, systems-on-chips (SoCs), chipsets, packages, components, or devices that individually or collectively constitute or include a processing system. The processing system may interface with other components of the wireless communication device 800 and may generally process information (such as inputs or signals) received from such other components and output information (such as outputs or signals) to such other components. In some implementations, an example chip may include a processing system, a first interface to output or transmit information, and a second interface to receive or obtain information. For example, the first interface may refer to an interface between the processing system of the chip and a transmission component, such that the wireless communication device 800 may transmit the information output from the chip. The second interface may refer to an interface between the processing system of the chip and a reception component, such that the wireless communication device 800 may receive information that is then passed to the processing system. In some implementations, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements, or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system may include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains, or transceivers. In some implementations, the processing system may include multiple independent or inter-connected processing systems.

In some implementations, the wireless communication device 800 can be configurable or configured for use in a STA (for example, a non-AP STA or non-AP MLD), such as the STA 104 described with reference to FIG. 1. In some other implementations, the wireless communication device 800 can be a STA (for example, a non-AP STA or non-AP MLD) that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of PPDUs and MPDUs conforming to one or more of the IEEE 802.11 family of wireless communication protocol standards. In some other implementations, the wireless communication device 800 can be configurable or configured to transmit and receive signals and communications conforming to one or more 3GPP specifications including those for 5G NR or 6G. In some implementations, the wireless communication device 800 also includes or can be coupled with one or more application processors which may be further coupled with one or more other memories. In some implementations, the wireless communication device 800 further includes a user interface (UI) (such as a touchscreen or keypad) and a display, which may be integrated with the UI to form a touchscreen display that is coupled with the processing system. In some implementations, the wireless communication device 800 may further include one or more sensors such as, for example, one or more inertial sensors, accelerometers, temperature sensors, pressure sensors, or altitude sensors, that are coupled with the processing system.

The wireless communication device 800 includes a first link component 825, a TSF component 830, a second link component 835, a beam sweeping component 840, a reporting component 845, and an NSA mode component 850. Portions of one or more of the first link component 825, the TSF component 830, the second link component 835, the beam sweeping component 840, the reporting component 845, and the NSA mode component 850 may be implemented at least in part in hardware or firmware. For example, one or more of the first link component 825, the TSF component 830, the second link component 835, the beam sweeping component 840, the reporting component 845, and the NSA mode component 850 may be implemented at least in part by at least a processor or a modem. In some implementations, portions of one or more of the first link component 825, the TSF component 830, the second link component 835, the beam sweeping component 840, the reporting component 845, and the NSA mode component 850 may be implemented at least in part by a processor and software in the form of processor-executable code stored in memory.

The wireless communication device 800 may support wireless communications in accordance with examples as disclosed herein. The first link component 825 is configurable or configured to communicate with an AP MLD via a first link corresponding to a first frequency band associated with omni-directional communications. A wireless communication device, processing system, or both may communicate information by transmitting (or otherwise outputting) the information, receiving (or otherwise obtaining) the information, or a combination thereof. That is, “communicating” may involve transmitting, outputting, receiving, obtaining, or any other form of communication. The TSF component 830 is configurable or configured to receive, via the first link, an indication of a first TSF value associated with a second link between the AP MLD and a non-AP MLD (such as the wireless communication device 800). The reporting component 845 is configurable or configured to communicate, with the AP MLD, a report indicating a second TSF value associated with reception of a sweep packet of one or more sweep packets for a beam sweeping procedure. In some implementations, the report may indicate a second TSF value associated with reception of a sweep packet at the AP MLD for a beam sweeping procedure performed at the non-AP MLD (such as the wireless communication device 800), where the reporting component 845 may be configurable or configured to receive or otherwise obtain, from the AP MLD, the report. In some other implementations, the report may indicate a second TSF value associated with reception of a sweep packet at the non-AP MLD (such as the wireless communication device 800) for a beam sweeping procedure performed at the AP MLD, where the reporting component 845 may be configurable or configured to transmit or otherwise output, to the AP MLD, the report. The second link component 835 is configurable or configured to communicate with the AP MLD via the second link corresponding to a second frequency band associated with directional communications in accordance with the beam sweeping procedure (such as the second TSF value indicated for the beam sweeping procedure) and the first TSF value associated with the second link. For example, the second link component 835 may be configurable or configured to communicate with the AP MLD in accordance with the first TSF value, the second TSF value, or both. The first TSF value may support timing synchronization between the first link and the second link, and the second TSF value may indicate a beam (such as a transmit beam) for communications via the second link.

In some implementations, the beam sweeping component 840 is configurable or configured to transmit one or more sweep packets, where the one or more sweep packets include a set of multiple sweep packets associated with a set of multiple respective transmit beams for the beam sweeping procedure, and where a sweep packet transmission for the set of multiple sweep packets corresponds to a respective TSF value of a set of multiple TSF values.

In some implementations, the reporting component 845 is configurable or configured to receive a report indicating a second TSF value of the set of multiple TSF values. In some implementations, the beam sweeping component 840 is configurable or configured to select a transmit beam for the second link corresponding to a sweep packet of the set of multiple sweep packets that is associated with the second TSF value.

In some implementations, the second TSF value is associated with the first link and is in accordance with the first TSF value associated with the second link. In some other implementations, the second TSF value is associated with the second link.

In some implementations, the report is received via the first link, via the second link, or both. In some implementations, the report is received via a multi-STA BA frame. In some other implementations, the report is aggregated with downlink data for the non-AP MLD.

In some implementations, the report further indicates an updated TSF value for the first link of the AP MLD or the second link of the AP MLD. In some implementations, selecting the transmit beam includes correcting the second TSF value in accordance with the updated TSF value.

In some implementations, the beam sweeping component 840 is configurable or configured to receive, via the first link, an indication of a time period (such as a dedicated time period) for the beam sweeping procedure, where the set of multiple TSF values are within the time period.

In some implementations, a sweep packet of the set of multiple sweep packets includes an LTF, a SIG, or both. In some implementations, each sweep packet of the set of multiple sweep packets includes a same pattern, such as a same pattern of bits or a same waveform. In some implementations, the beam sweeping component 840 is configurable or configured to receive, via the first link, an indication of the same pattern of bits or the same waveform for the set of multiple sweep packets.

In some implementations, the beam sweeping component 840 is configurable or configured to receive one or more sweep packets associated with one or more respective TSF values for the beam sweeping procedure. In some implementations, the reporting component 845 is configurable or configured to transmit a report indicating a second TSF value associated with reception of a sweep packet of the one or more sweep packets, the sweep packet satisfying a signal strength threshold.

In some implementations, the second TSF value is associated with the first link and is in accordance with the first TSF value associated with the second link. In some other implementations, the second TSF value is associated with the second link.

In some implementations, the report is transmitted via the first link, via the second link, or both. In some implementations, the report is transmitted via a multi-STA BA frame.

In some implementations, the beam sweeping component 840 is configurable or configured to monitor a transmit period for the one or more sweep packets via the second link, where the transmit period may be common to a set of multiple non-AP MLDs. In some implementations, the reporting component 845 is configurable or configured to receive, via the first link, a TF associated with the transmit period, where a TB-PPDU that includes the report is transmitted via the first link in accordance with the TF. In some implementations, the TF includes at least one of an MU-BAR, a basic TF, a BSRP, and a short feedback poll variant (such as a beamforming report poll (BFRP), a bandwidth query report poll (BQRP), an NFRP, a BSRP, or a relatively shorter variant of any such polling signals). In some implementations, the TF indicates a dedicated RU for transmission of the report, an RA-RU for transmission of the report, or both. In some implementations, the report is transmitted via the RA-RU in accordance with an AID value (such as a special AID value) dedicated for beamforming feedback reception for the second link.

In some implementations, the beam sweeping component 840 is configurable or configured to receive, via the first link, a short feedback report poll, a BSRP, or both associated with beam training feedback. In some implementations, the beam sweeping component 840 is configurable or configured to transmit, via the first link, a response frame in accordance with the short feedback report poll, the BSRP, or both indicating a training mode for the non-AP MLD, where the TF indicates a dedicated RU for the non-AP MLD in accordance with the response frame indicating that the training mode is associated with a beam training procedure.

In some implementations, the reporting component 845 is configurable or configured to receive, via the first link, an indication of a channel access period (such as a special channel access period) associated with feedback for the beam sweeping procedure, where the report is transmitted in accordance with the channel access period.

In some implementations, the TSF component 830 is configurable or configured to receive an indication of an updated TSF value for the first link of the AP MLD or the second link of the AP MLD, where the TSF value associated with reception of the sweep packet is corrected in accordance with the updated TSF value.

In some implementations, the reporting component 845 is configurable or configured to receive, via the first link, a TSF poll frame indicating the non-AP MLD, where the report is transmitted in accordance with the TSF poll frame and is transmitted via a frequency tone that is mapped to the TSF value associated with reception of the sweep packet. In some implementations, the reporting component 845 is configurable or configured to receive one or more poll messages (such as short feedback report polls) corresponding to the one or more sweep packets, where the report is transmitted in accordance with a poll message (such as a short feedback report poll) of the one or more poll messages corresponding to the TSF value associated with reception of the sweep packet.

In some implementations, the NSA mode component 850 is configurable or configured to operate in an NSA mode, where the first link includes a partner link for the second link in the NSA mode.

In some implementations, the beam sweeping component 840 is configurable or configured to trigger the beam sweeping procedure in accordance with establishment of an association with the AP MLD, an inactivity timer for the non-AP MLD, a reference signal indicating beam misalignment for the second frequency band, or any combination thereof.

In some implementations, the TSF component 830 is configurable or configured to receive a periodic update to a first TSF value for the first link of the AP MLD, a second TSF value for the second link of the AP MLD, or both, where the periodic update includes a partial TSF value or a full TSF value. In some implementations, the periodic update includes at least one of an FD frame, a broadcast probe response frame, and a broadcast or individually addressed frame. In some implementations, a field including the partial TSF value or the full TSF value is integrity protected, encryption protected, or both. In some implementations, the TSF value includes a zero value or a non-zero value indicating a TSF offset between the first link and the second link.

In some implementations, the beam sweeping component 840 is configurable or configured to receive an indication of a start time for the beam sweeping procedure and delay the start time for the beam sweeping procedure in accordance with a periodicity at which the start time is indicated.

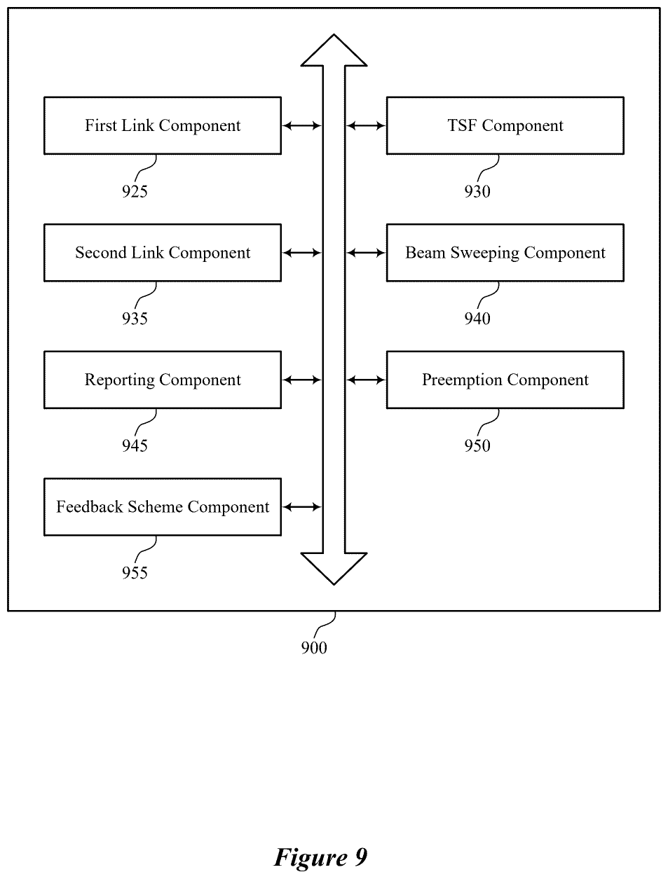

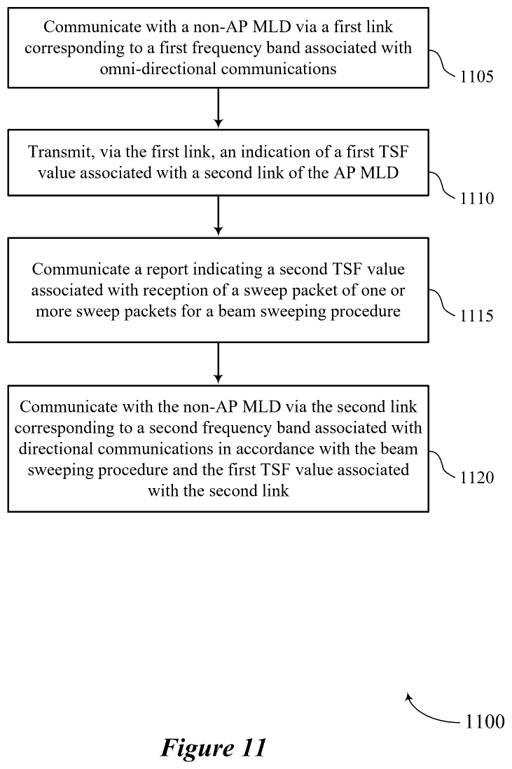

FIG. 9 shows a block diagram of an example wireless communication device 900 that supports IMMW beam training for MLO. In some implementations, the wireless communication device 900 is configured to perform the process 1100 described with reference to FIG. 11. The wireless communication device 900 may include one or more chips, SoCs, chipsets, packages, components, or devices that individually or collectively constitute or include a processing system. The processing system may interface with other components of the wireless communication device 900 and may generally process information (such as inputs or signals) received from such other components and output information (such as outputs or signals) to such other components. In some implementations, an example chip may include a processing system, a first interface to output or transmit information, and a second interface to receive or obtain information. For example, the first interface may refer to an interface between the processing system of the chip and a transmission component, such that the wireless communication device 900 may transmit the information output from the chip. The second interface may refer to an interface between the processing system of the chip and a reception component, such that the wireless communication device 900 may receive information that is then passed to the processing system. In some implementations, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements, or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains, or transceivers.

In some implementations, the wireless communication device 900 can be configurable or configured for use in an AP (for example, an AP STA or an AP MLD), such as the AP 102 described with reference to FIG. 1. In some other implementations, the wireless communication device 900 can be an AP (for example, an AP STA or an AP MLD) that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of PPDUs and MPDUs conforming to one or more of the IEEE 802.11 family of wireless communication protocol standards. In some other implementations, the wireless communication device 900 can be configurable or configured to transmit and receive signals and communications conforming to one or more 3GPP specifications including those for 5G NR or 6G. In some implementations, the wireless communication device 900 also includes or can be coupled with one or more application processors which may be further coupled with one or more other memories. In some implementations, the wireless communication device 900 further includes at least one external network interface coupled with the processing system that enables communication with a core network or backhaul network that enables the wireless communication device 900 to gain access to external networks including the Internet.

The wireless communication device 900 includes a first link component 925, a TSF component 930, a second link component 935, a beam sweeping component 940, a reporting component 945, a preemption component 950, and a feedback scheme component 955. Portions of one or more of the first link component 925, the TSF component 930, the second link component 935, the beam sweeping component 940, the reporting component 945, the preemption component 950, and the feedback scheme component 955 may be implemented at least in part in hardware or firmware. For example, one or more of the first link component 925, the TSF component 930, the second link component 935, the beam sweeping component 940, the reporting component 945, the preemption component 950, and the feedback scheme component 955 may be implemented at least in part by at least a processor or a modem. In some implementations, portions of one or more of the first link component 925, the TSF component 930, the second link component 935, the beam sweeping component 940, the reporting component 945, the preemption component 950, and the feedback scheme component 955 may be implemented at least in part by a processor and software in the form of processor-executable code stored in memory.

The wireless communication device 900 may support wireless communications in accordance with examples as disclosed herein. The first link component 925 is configurable or configured to communicate with a non-AP MLD via a first link corresponding to a first frequency band associated with omni-directional communications. The TSF component 930 is configurable or configured to transmit, via the first link, an indication of a first TSF value associated with a second link between the AP MLD (such as the wireless communication device 900) and the non-AP MLD. The reporting component 945 is configurable or configured to communicate, with the non-AP MLD, a report indicating a second TSF value associated with reception of a sweep packet of one or more sweep packets for a beam sweeping procedure. In some implementations, the report may indicate a second TSF value associated with reception of a sweep packet at the AP MLD (such as the wireless communication device 900) for a beam sweeping procedure performed at the non-AP MLD, where the reporting component 945 may be configurable or configured to transmit or otherwise output, to the non-AP MLD, the report. In some other implementations, the report may indicate a second TSF value associated with reception of a sweep packet at the non-AP MLD for a beam sweeping procedure performed at the AP MLD (such as the wireless communication device 900), where the reporting component 945 may be configurable or configured to receive or otherwise obtain, from the non-AP MLD, the report. The second link component 935 is configurable or configured to communicate with the non-AP MLD via the second link corresponding to a second frequency band associated with directional communications in accordance with the beam sweeping procedure (such as the second TSF value indicated for the beam sweeping procedure) and the first TSF value associated with the second link. For example, the second link component 935 may be configurable or configured to communicate with the non-AP MLD in accordance with the first TSF value, the second TSF value, or both. The first TSF value may support timing synchronization between the first link and the second link, and the second TSF value may indicate a beam (such as a transmit beam) for communications via the second link.

In some implementations, the beam sweeping component 940 is configurable or configured to transmit one or more sweep packets, where the one or more sweep packets include a set of multiple sweep packets associated with a set of multiple respective transmit beams for the beam sweeping procedure, and where a sweep packet transmission for the set of multiple sweep packets corresponds to a respective TSF value of a set of multiple TSF values.

In some implementations, the reporting component 945 is configurable or configured to receive a report associated with the non-AP MLD that indicates a second TSF value of the set of multiple TSF values. In some implementations, the beam sweeping component 940 is configurable or configured to select a transmit beam for the second link corresponding to a sweep packet of the set of multiple sweep packets that is associated with the second TSF value.

In some implementations, the second TSF value is associated with the first link and is in accordance with the first TSF value associated with the second link. In some other implementations, the second TSF value is associated with the second link.

In some implementations, the report is received via the first link, via the second link, or both. In some implementations, the report is received via a multi-STA BA frame.

In some implementations, the reporting component 945 is configurable or configured to transmit, via the first link, an indication of a channel access period (such as a special channel access period) associated with feedback for the beam sweeping procedure, where the report is received in accordance with the channel access period.

In some implementations, the TSF component 930 is configurable or configured to transmit an indication of an updated TSF value for the first link of the AP MLD or the second link of the AP MLD, where the second TSF value is in accordance with the updated TSF value.

In some implementations, the reporting component 945 is configurable or configured to transmit, via the first link, a TSF poll frame indicating the non-AP MLD, where the report is received in accordance with the TSF poll frame and is received via a frequency tone that is mapped to the indicated TSF.

In some implementations, the reporting component 945 is configurable or configured to transmit a set of multiple poll messages (such as short feedback report polls) corresponding to the set of multiple sweep packets, where the report is received in accordance with a poll message of the set of multiple poll messages corresponding to the second TSF value.

In some implementations, a sweep packet of the set of multiple sweep packets includes an LTF, a SIG, or both. In some implementations, each sweep packet of the set of multiple sweep packets includes a same pattern, such as a same pattern of bits or a same waveform. In some implementations, the beam sweeping component 940 is configurable or configured to transmit, via the first link, an indication of the same pattern (such as the same pattern of bits or the same waveform) for the set of multiple sweep packets.

In some implementations, the set of multiple TSF values is within a transmit period for the set of multiple sweep packets via the second link, where the transmit period may be common to a set of multiple non-AP MLDs. In some implementations, the reporting component 945 is configurable or configured to receive a set of multiple reports associated with the set of multiple non-AP MLDs that indicate respective TSF values of the set of multiple TSF values in accordance with the transmit period. In some implementations, the set of multiple reports is received via a multi-STA BA frame.

In some implementations, the reporting component 945 is configurable or configured to transmit, via the first link, a TF associated with the transmit period, where a TB-PPDU that includes the set of multiple reports is received in accordance with the TF. In some implementations, the TF includes at least one of an MU-BAR, a basic TF, a BSRP, and a short feedback poll variant. In some implementations, the TF indicates one or more dedicated RUs, one or more RA-RUs, or a combination thereof for the set of multiple reports.

In some implementations, to support receiving the set of multiple reports, the reporting component 945 is configurable or configured to receive a report associated with the non-AP MLD via an RA-RU of the one or more RA-RUs in accordance with an AID value (such as a special AID value) dedicated for beamforming feedback reception for the second link.

In some implementations, the reporting component 945 is configurable or configured to transmit, via the first link, a short feedback report poll, a BSRP, or both associated with beam training feedback. In some implementations, the reporting component 945 is configurable or configured to receive, via the first link, a response frame in accordance with the short feedback report poll, the BSRP, or both indicating a training mode for the non-AP MLD, where the TF indicates a dedicated RU for the non-AP MLD in accordance with the response frame indicating that the training mode is associated with a beam training procedure.

In some implementations, the set of multiple respective transmit beams are associated with a first subset of sectors for the AP MLD, and the beam sweeping component 940 is configurable or configured to transmit, within a second transmit period, a second set of multiple sweep packets associated with a second set of multiple respective transmit beams, where the second set of multiple respective transmit beams are associated with a second subset of sectors for the AP MLD different from the first subset of sectors.

In some implementations, the beam sweeping component 940 is configurable or configured to receive one or more sweep packets associated with one or more respective TSF values for the beam sweeping procedure. In some implementations, the reporting component 945 is configurable or configured to transmit a report indicating a TSF value associated with reception of a sweep packet of the one or more sweep packets, the sweep packet satisfying a signal strength threshold.

In some implementations, the second TSF value is associated with the first link and is in accordance with the first TSF value associated with the second link. In some other implementations, the second TSF value is associated with the second link.

In some implementations, the report is transmitted via the first link, via the second link, or both. In some implementations, to support transmitting the report, the reporting component 945 is configurable or configured to aggregate the report with downlink data for the non-AP MLD. In some implementations, the report further indicates an updated TSF value for the first link of the AP MLD or the second link of the AP MLD.

In some implementations, the beam sweeping component 940 is configurable or configured to transmit, via the first link, an indication of a time period (such as a dedicated time period) for the beam sweeping procedure. In some implementations, the beam sweeping component 940 is configurable or configured to monitor the time period for the one or more sweep packets via the second link, where the one or more respective TSF values are within the time period.

In some implementations, the TSF component 930 is configurable or configured to transmit a periodic update to the first TSF value associated with the second link of the AP MLD, where the periodic update to the first TSF value includes a partial TSF value or a full TSF value. In some implementations, the periodic update includes at least one of an FD frame, a broadcast probe response frame, and a broadcast or individually addressed frame. In some implementations, a field including the partial TSF value or the full TSF value is integrity protected, encryption protected, or both.

In some implementations, the preemption component 950 is configurable or configured to transmit, to an additional non-AP MLD, a preemption request associated with preempting a TXOP of the additional non-AP MLD via the first frequency band. In some implementations, the reporting component 945 is configurable or configured to communicate, via the first link, a report associated with the beam sweeping procedure for the non-AP MLD via the preempted TXOP.

In some implementations, the reporting component 945 is configurable or configured to communicate, via the first link, a report associated with the beam sweeping procedure for the non-AP MLD via one or more TDMed resources of a TXOP associated with an additional AP MLD via the first frequency band.

In some implementations, the feedback scheme component 955 is configurable or configured to select a feedback scheme in accordance with a first quantity of sectors associated with the beam sweeping procedure, a second quantity of non-AP MLDs associated with the beam sweeping procedure, or a combination thereof. In some implementations, the feedback scheme may include a preemption-based feedback scheme, a TXOP sharing-based feedback scheme, a first TSF polling feedback scheme associated with one or more STAs, a second TSF polling feedback scheme associated with one or more beams, or any combination thereof.

In some implementations, the first TSF value includes a zero value or a non-zero value indicating a TSF offset between the first link and the second link.

In some implementations, the beam sweeping component 940 is configurable or configured to transmit an indication of a start time for the beam sweeping procedure and delay the start time for the beam sweeping procedure in accordance with a periodicity at which the start time is indicated.

FIG. 10 shows a flowchart illustrating an example process 1000 performable by or at a non-AP MLD that supports IMMW beam training for MLO. The operations of the process 1000 may be implemented by a non-AP MLD or its components as described herein. For example, the process 1000 may be performed by a wireless communication device, such as the wireless communication device 800 described with reference to FIG. 8, operating as or within a wireless STA. In some implementations, the process 1000 may be performed by a wireless STA, such as one of the STAs 104 described with reference to FIG. 1.

In some implementations, in 1005, the non-AP MLD may communicate with an AP MLD via a first link corresponding to a first frequency band associated with omni-directional communications. The operations of 1005 may be performed in accordance with examples as disclosed herein. In some implementations, aspects of the operations of 1005 may be performed by a first link component 825 as described with reference to FIG. 8.

In some implementations, in 1010, the non-AP MLD may receive, via the first link, an indication of a first TSF value associated with a second link of the AP MLD. The operations of 1010 may be performed in accordance with examples as disclosed herein. In some implementations, aspects of the operations of 1010 may be performed by a TSF component 830 as described with reference to FIG. 8.

In some implementations, in 1015, the non-AP MLD may communicate a report indicating a second TSF value associated with reception of a sweep packet of one or more sweep packets for a beam sweeping procedure. The operations of 1015 may be performed in accordance with examples as disclosed herein. In some implementations, aspects of the operations of 1015 may be performed by a reporting component 845 as described with reference to FIG. 8.

In some implementations, in 1020, the non-AP MLD may communicate with the AP MLD via the second link corresponding to a second frequency band associated with directional communications in accordance with the beam sweeping procedure and the first TSF value associated with the second link. The operations of 1020 may be performed in accordance with examples as disclosed herein. In some implementations, aspects of the operations of 1020 may be performed by a second link component 835 as described with reference to FIG. 8.

FIG. 11 shows a flowchart illustrating an example process 1100 performable by or at an AP MLD that supports IMMW beam training for MLO. The operations of the process 1100 may be implemented by an AP MLD or its components as described herein. For example, the process 1100 may be performed by a wireless communication device, such as the wireless communication device 900 described with reference to FIG. 9, operating as or within a wireless AP. In some implementations, the process 1100 may be performed by a wireless AP, such as one of the APs 102 described with reference to FIG. 1.

In some implementations, in 1105, the AP MLD may communicate with a non-AP MLD via a first link corresponding to a first frequency band associated with omni-directional communications. The operations of 1105 may be performed in accordance with examples as disclosed herein. In some implementations, aspects of the operations of 1105 may be performed by a first link component 925 as described with reference to FIG. 9.

In some implementations, in 1110, the AP MLD may transmit, via the first link, an indication of a first TSF value associated with a second link of the AP MLD. The operations of 1110 may be performed in accordance with examples as disclosed herein. In some implementations, aspects of the operations of 1110 may be performed by a TSF component 930 as described with reference to FIG. 9.

In some implementations, in 1115, the AP MLD may communicate a report indicating a second TSF value associated with reception of a sweep packet of one or more sweep packets for a beam sweeping procedure. The operations of 1115 may be performed in accordance with examples as disclosed herein. In some implementations, aspects of the operations of 1115 may be performed by a reporting component 945 as described with reference to FIG. 9.

In some implementations, in 1120, the AP MLD may communicate with the non-AP MLD via the second link corresponding to a second frequency band associated with directional communications in accordance with the beam sweeping procedure and the first TSF value associated with the second link. The operations of 1120 may be performed in accordance with examples as disclosed herein. In some implementations, aspects of the operations of 1120 may be performed by a second link component 935 as described with reference to FIG. 9.

Implementation examples are described in the following numbered clauses:

Aspect 1: A non-AP MLD, including: a processing system that includes processor circuitry and memory circuitry that stores code, the processing system configured to cause the non-AP MLD to: communicate with an AP MLD via a first link corresponding to a first frequency band associated with omni-directional communications; obtain, via the first link, an indication of a first TSF value associated with a second link between the AP MLD and the non-AP MLD; communicate, with the AP MLD, a report indicating a second TSF value associated with reception of a sweep packet of one or more sweep packets for a beam sweeping procedure; and communicate with the AP MLD via the second link corresponding to a second frequency band associated with directional communications in accordance with the beam sweeping procedure and the first TSF value associated with the second link.

Aspect 2: The non-AP MLD of aspect 1, where the processing system is further configured to cause the non-AP MLD to: output the one or more sweep packets, where the one or more sweep packets include a set of multiple sweep packets associated with a set of multiple respective transmit beams for the beam sweeping procedure, and where the report is obtained in accordance with the beam sweeping procedure.

Aspect 3: The non-AP MLD of aspect 2, where the processing system is further configured to cause the non-AP MLD to: select a transmit beam for the second link that corresponds to the sweep packet of the one or more sweep packets in accordance with the report indicating the second TSF value associated with the reception of the sweep packet.

Aspect 4: The non-AP MLD of aspect 3, where the report further indicates an updated TSF value for the first link of the AP MLD or the second link of the AP MLD, and where selecting the transmit beam includes correcting the second TSF value associated with the reception of the sweep packet in accordance with the updated TSF value.

Aspect 5: The non-AP MLD of any of aspects 2-4, where the report is obtained via the first link, via the second link, or both.

Aspect 6: The non-AP MLD of any of aspects 2-5, where the report is aggregated with downlink data for the non-AP MLD.

Aspect 7: The non-AP MLD of any of aspects 2-5, where the report is obtained via a multi-STA BA frame.

Aspect 8: The non-AP MLD of any of aspects 2-7, where the processing system is further configured to cause the non-AP MLD to: obtain, via the first link, an indication of a time period for the beam sweeping procedure, where the set of multiple TSF values are within the time period.

Aspect 9: The non-AP MLD of any of aspects 2-8, where each sweep packet of the set of multiple sweep packets includes an LTF, a SIG, or both.

Aspect 10: The non-AP MLD of any of aspects 2-9, where each sweep packet of the set of multiple sweep packets includes a same pattern of bits.

Aspect 11: The non-AP MLD of aspect 10, where the processing system is further configured to cause the non-AP MLD to: obtain, via the first link, an indication of the same pattern of bits for the set of multiple sweep packets.

Aspect 12: The non-AP MLD of any of aspects 2-11, where a sweep packet transmission for the set of multiple sweep packets corresponds to a respective TSF value of a set of multiple TSF values.

Aspect 13: The non-AP MLD of any of aspects 1-12, where the processing system is further configured to cause the non-AP MLD to: obtain the one or more sweep packets for the beam sweeping procedure, where the one or more sweep packets are associated with one or more respective TSF values, and the report is outputted in accordance with obtaining the one or more sweep packets and the sweep packet satisfying a signal strength threshold.

Aspect 14: The non-AP MLD of aspect 13, where the report is outputted via the first link, via the second link, or both.

Aspect 15: The non-AP MLD of either of aspects 13 or 14, where the report is outputted via a multi-STA BA frame.

Aspect 16: The non-AP MLD of any of aspects 13-15, where the processing system is further configured to cause the non-AP MLD to: monitor a transmit period for the one or more sweep packets via the second link, where the transmit period is common to a set of multiple non-AP MLDs.

Aspect 17: The non-AP MLD of aspect 16, where the processing system is further configured to cause the non-AP MLD to: obtain, via the first link, a trigger indication associated with the transmit period, where the report is outputted via the first link in accordance with the trigger indication.

Aspect 18: The non-AP MLD of aspect 16, where the processing system is further configured to cause the non-AP MLD to: obtain, via the first link, a TF associated with the transmit period.

Aspect 19: The non-AP MLD of aspect 18, where: the TF includes at least one of an MU-BAR, a basic TF, a BSRP) and a short feedback poll variant; the TF indicates a dedicated RU for transmission of the report, an RA-RU for transmission of the report, or both; or any combination thereof.

Aspect 20: The non-AP MLD of aspect 19, where the report is outputted via the RA-RU in accordance with an AID value dedicated for beamforming feedback reception for the second link.

Aspect 21: The non-AP MLD of any of aspects 18-20, where the processing system is further configured to cause the non-AP MLD to: obtain, via the first link, a short feedback report poll, a BSRP, or both associated with beam training feedback; and output, via the first link, a response frame in accordance with the short feedback report poll, the BSRP, or both indicating a training mode for the non-AP MLD, where the TF indicates a dedicated RU for the non-AP MLD in accordance with the response frame indicating that the training mode is associated with a beam training procedure.

Aspect 22: The non-AP MLD of any of aspects 18-21, where a TB-PPDU that includes the report is outputted via the first link in accordance with the TF.

Aspect 23: The non-AP MLD of any of aspects 13-22, where the processing system is further configured to cause the non-AP MLD to: obtain, via the first link, an indication of a channel access period associated with feedback for the beam sweeping procedure, where the report is outputted in accordance with the channel access period.

Aspect 24: The non-AP MLD of any of aspects 13-23, where the processing system is further configured to cause the non-AP MLD to: obtain an indication of an updated TSF value for the first link of the AP MLD or the second link of the AP MLD, where the second TSF value associated with the reception of the sweep packet is corrected in accordance with the updated TSF value.

Aspect 25: The non-AP MLD of any of aspects 13-24, where the processing system is further configured to cause the non-AP MLD to: obtain, via the first link, a TSF poll frame indicating the non-AP MLD, where the report is outputted in accordance with the TSF poll frame and is outputted via a frequency tone that is mapped to the second TSF value associated with the reception of the sweep packet.

Aspect 26: The non-AP MLD of any of aspects 13-25, where the processing system is further configured to cause the non-AP MLD to: obtain one or more poll messages corresponding to the one or more sweep packets, where the report is outputted in accordance with a poll message of the one or more poll messages corresponding to the second TSF value associated with the reception of the sweep packet.

Aspect 27: The non-AP MLD of any of aspects 1-26, where: the second TSF value associated with the reception of the sweep packet is further associated with the first link and the first TSF value associated with the second link; or the second TSF value associated with the reception of the sweep packet is further associated with the second link.

Aspect 28: The non-AP MLD of any of aspects 1-27, where the processing system is further configured to cause the non-AP MLD to: operate in an NSA mode, where the first link includes a partner link for the second link in the NSA mode.

Aspect 29: The non-AP MLD of any of aspects 1-28, where the processing system is further configured to cause the non-AP MLD to: trigger the beam sweeping procedure in accordance with establishment of an association with the AP MLD, an inactivity timer for the non-AP MLD, a reference signal indicating beam misalignment for the second frequency band, or any combination thereof.

Aspect 30: The non-AP MLD of any of aspects 1-29, where the processing system is further configured to cause the non-AP MLD to: obtain a periodic update to a third TSF value for the first link of the AP MLD, a fourth TSF value for the second link of the AP MLD, or both, where the periodic update includes a partial TSF value or a full TSF value.

Aspect 31: The non-AP MLD of aspect 30, where: the periodic update includes at least one of an FD frame, a broadcast probe response frame, and a broadcast or individually addressed frame; a field including the partial TSF value or the full TSF value is integrity protected, encryption protected, or both; or any combination thereof.

Aspect 32: The non-AP MLD of any of aspects 1-31, where the first TSF value associated with the second link includes a zero value or a non-zero value indicating a TSF offset between the first link and the second link.

Aspect 33: The non-AP MLD of any of aspects 1-32, where the processing system is further configured to cause the non-AP MLD to: obtain an indication of a start time for the beam sweeping procedure; and delay the start time for the beam sweeping procedure in accordance with a periodicity at which the start time is indicated.

Aspect 34: An AP MLD, including: a processing system that includes processor circuitry and memory circuitry that stores code, the processing system configured to cause the AP MLD to: communicate with a non-AP MLD via a first link corresponding to a first frequency band associated with omni-directional communications; output, via the first link, an indication of a first TSF value associated with a second link between the AP MLD and the non-AP MLD; communicate, with the non-AP MLD, a report indicating a second TSF value associated with reception of a sweep packet of one or more sweep packets for a beam sweeping procedure; and communicate with the non-AP MLD via the second link corresponding to a second frequency band associated with directional communications in accordance with the beam sweeping procedure and the first TSF value associated with the second link.

Aspect 35: The AP MLD of aspect 34, where the processing system is further configured to cause the AP MLD to: output the one or more sweep packets, where the one or more sweep packets include a set of multiple sweep packets associated with a set of multiple respective transmit beams for the beam sweeping procedure, and where the report is obtained in accordance with the beam sweeping procedure.

Aspect 36: The AP MLD of aspect 35, where the processing system is further configured to cause the AP MLD to: select a transmit beam for the second link that corresponds to the sweep packet of the one or more sweep packets in accordance with the report indicating the second TSF value associated with the reception of the sweep packet.

Aspect 37: The AP MLD of either of aspects 35 or 36, where the report is obtained via the first link, via the second link, or both.

Aspect 38: The AP MLD of any of aspects 35-37, where the report is obtained via a multi-STA BA frame.

Aspect 39: The AP MLD of any of aspects 35-38, where the processing system is further configured to cause the AP MLD to: output, via the first link, an indication of a channel access period associated with feedback for the beam sweeping procedure, where the report is obtained in accordance with the channel access period.

Aspect 40: The AP MLD of any of aspects 35-39, where the processing system is further configured to cause the AP MLD to: output an indication of an updated TSF value for the first link of the AP MLD or the second link of the AP MLD, where the second TSF value is corrected in accordance with the updated TSF value.

Aspect 41: The AP MLD of any of aspects 35-40, where the processing system is further configured to cause the AP MLD to: output, via the first link, a TSF poll frame indicating the non-AP MLD, where the report is obtained in accordance with the TSF poll frame and is obtained via a frequency tone that is mapped to the second TSF value associated with the reception of the sweep packet.

Aspect 42: The AP MLD of any of aspects 35-41, where the processing system is further configured to cause the AP MLD to: output a set of multiple poll messages corresponding to the set of multiple sweep packets, where the report is obtained in accordance with a poll message of the set of multiple poll messages corresponding to the second TSF value associated with the reception of the sweep packet.

Aspect 43: The AP MLD of any of aspects 35-42, where each sweep packet of the set of multiple sweep packets includes an LTF, a SIG, or both.

Aspect 44: The AP MLD of any of aspects 35-43, where each sweep packet of the set of multiple sweep packets includes a same pattern of bits.

Aspect 45: The AP MLD of aspect 44, where the processing system is further configured to cause the AP MLD to: output, via the first link, an indication of the same pattern of bits for the set of multiple sweep packets.

Aspect 46: The AP MLD of any of aspects 35-45, where the set of multiple TSF values are within a transmit period for the set of multiple sweep packets, and where the transmit period is common to a set of multiple non-AP MLDs.

Aspect 47: The AP MLD of aspect 46, where the processing system is further configured to cause the AP MLD to: obtain a set of multiple reports associated with the set of multiple non-AP MLDs that indicate respective TSF values of the set of multiple TSF values in accordance with the transmit period.

Aspect 48: The AP MLD of aspect 47, where the set of multiple reports is obtained via a multi-STA BA frame.

Aspect 49: The AP MLD of either of aspects 47 or 48, where the processing system is further configured to cause the AP MLD to: output, via the first link, a trigger indication associated with the transmit period, where the set of multiple reports is obtained in accordance with the trigger indication.

Aspect 50: The AP MLD of either of aspects 47 or 48, where the processing system is further configured to cause the AP MLD to: output, via the first link, a TF associated with the transmit period.

Aspect 51: The AP MLD of aspect 50, where: the TF includes at least one of an MU-BAR, a basic TF, a BSRP, and a short feedback poll variant; the TF indicates one or more dedicated RUs, one or more RA-RUs, or a combination thereof for the set of multiple reports; or any combination thereof.

Aspect 52: The AP MLD of aspect 51, where, to obtain the set of multiple reports, the processing system is configured to cause the AP MLD to: obtain a report associated with the non-AP MLD via an RA-RU of the one or more RA-RUs in accordance with an AID value dedicated for beamforming feedback reception for the second link.

Aspect 53: The AP MLD of any of aspects 50-52, where the processing system is further configured to cause the AP MLD to: output, via the first link, a short feedback report poll, a BSRP, or both associated with beam training feedback; and obtain, via the first link, a response frame in accordance with the short feedback report poll, the BSRP, or both indicating a training mode for the non-AP MLD, where the TF indicates a dedicated RU for the non-AP MLD in accordance with the response frame indicating that the training mode is associated with a beam training procedure.

Aspect 54: The AP MLD of any of aspects 50-53, where a TB-PPDU includes the set of multiple reports in accordance with the TF.

Aspect 55: The AP MLD of any of aspects 46-54, where the set of multiple respective transmit beams are associated with a first subset of sectors for the AP MLD, and the processing system is further configured to cause the AP MLD to: output, within a second transmit period, a second set of multiple sweep packets associated with a second set of multiple respective transmit beams, where the second set of multiple respective transmit beams are associated with a second subset of sectors for the AP MLD different from the first subset of sectors.

Aspect 56: The AP MLD of any of aspects 35-55, where a sweep packet transmission for the set of multiple sweep packets corresponds to a respective TSF value of a set of multiple TSF values.

Aspect 57: The AP MLD of any of aspects 34-56, where the processing system is further configured to cause the AP MLD to: obtain the one or more sweep packets for the beam sweeping procedure, where the one or more sweep packets are associated with one or more respective TSF values, and the report is outputted in accordance with obtaining the one or more sweep packets and the sweep packet satisfying a signal strength threshold.

Aspect 58: The AP MLD of aspect 57, where the report is outputted via the first link, via the second link, or both.

Aspect 59: The AP MLD of either of aspects 57 or 58, where, to communicate the report, the processing system is further configured to cause the AP MLD to: aggregate the report with downlink data for the non-AP MLD.

Aspect 60: The AP MLD of any of aspects 57-59, where the report further indicates an updated TSF value for the first link of the AP MLD or the second link of the AP MLD.

Aspect 61: The AP MLD of any of aspects 57-60, where the processing system is further configured to cause the AP MLD to: output, via the first link, an indication of a time period for the beam sweeping procedure; and monitor the time period for the one or more sweep packets via the second link, where the one or more respective TSF values are within the time period.

Aspect 62: The AP MLD of any of aspects 34-61, where the processing system is further configured to cause the AP MLD to: output a periodic update to the first TSF value associated with the second link of the AP MLD, where the periodic update to the first TSF value includes a partial TSF value or a full TSF value.

Aspect 63: The AP MLD of aspect 62, where: the periodic update includes at least one of an FD frame, a broadcast probe response frame, and a broadcast or individually addressed frame; a field including the partial TSF value or the full TSF value is integrity protected, encryption protected, or both; or any combination thereof.

Aspect 64: The AP MLD of any of aspects 34-63, where: the second TSF value associated with the reception of the sweep packet is further associated with the first link and the first TSF value associated with the second link; or the second TSF value associated with the reception of the sweep packet is further associated with the second link.

Aspect 65: The AP MLD of any of aspects 34-64, where the processing system is further configured to cause the AP MLD to: output, to an additional non-AP MLD, a preemption request associated with preempting a TXOP of the additional non-AP MLD via the first frequency band, where the report is communicated via the preempted TXOP.

Aspect 66: The AP MLD of any of aspects 34-65, where the report is communicated via one or more TDMed resources of a TXOP associated with an additional AP MLD via the first frequency band.

Aspect 67: The AP MLD of any of aspects 34-66, where the processing system is further configured to cause the AP MLD to: select a feedback scheme in accordance with a first quantity of sectors associated with the beam sweeping procedure, a second quantity of non-AP MLDs associated with the beam sweeping procedure, or a combination thereof.

Aspect 68: The AP MLD of aspects 67, where the feedback scheme includes a preemption-based feedback scheme, a TXOP sharing-based feedback scheme, a first TSF polling feedback scheme associated with one or more STAs, a second TSF polling feedback scheme associated with one or more beams, or any combination thereof.

Aspect 69: The AP MLD of any of aspects 34-68, where the first TSF value includes a zero value or a non-zero value indicating a TSF offset between the first link and the second link.

Aspect 70: The AP MLD of any of aspects 34-69, where the processing system is further configured to cause the AP MLD to: output an indication of a start time for the beam sweeping procedure; and delay the start time for the beam sweeping procedure in accordance with a periodicity at which the start time is indicated.

Aspect 71: A method for wireless communications at a non-AP MLD, including: communicating with an AP MLD via a first link corresponding to a first frequency band associated with omni-directional communications; receiving, via the first link, an indication of a first TSF value associated with a second link between the AP MLD and the non-AP MLD; communicating, with the AP MLD, a report indicating a second TSF value associated with reception of a sweep packet of one or more sweep packets for a beam sweeping procedure; and communicating with the AP MLD via the second link corresponding to a second frequency band associated with directional communications in accordance with the beam sweeping procedure and the first TSF value associated with the second link.

Aspect 72: The method of aspect 71, further including: transmitting the one or more sweep packets, where the one or more sweep packets include a set of multiple sweep packets associated with a set of multiple respective transmit beams for the beam sweeping procedure, and where the report is received in accordance with the beam sweeping procedure.

Aspect 73: The method of aspect 72, further including: selecting a transmit beam for the second link that corresponds to the sweep packet of the one or more sweep packets in accordance with the report indicating the second TSF value associated with the reception of the sweep packet.

Aspect 74: The method of aspect 73, where the report further indicates an updated TSF value for the first link of the AP MLD or the second link of the AP MLD, where selecting the transmit beam includes correcting the second TSF value associated with the reception of the sweep packet in accordance with the updated TSF value.

Aspect 75: The method of any of aspects 72-74, where the report is received via the first link, via the second link, or both.

Aspect 76: The method of any of aspects 72-75, where the report is aggregated with downlink data for the non-AP MLD.

Aspect 77: The method of any of aspects 72-75, where the report is received via a multi-STA BA frame.

Aspect 78: The method of any of aspects 72-77, further including: receiving, via the first link, an indication of a time period for the beam sweeping procedure, where the set of multiple TSF values are within the time period.

Aspect 79: The method of any of aspects 72-78, where each sweep packet of the set of multiple sweep packets includes a long training field, a signal field, or both.

Aspect 80: The method of any of aspects 72-79, where each sweep packet of the set of multiple sweep packets includes a same pattern of bits.

Aspect 81: The method of aspect 80, further including: receiving, via the first link, an indication of the same pattern of bits for the set of multiple sweep packets.

Aspect 82: The method of any of aspects 72-81, where a sweep packet transmission for the set of multiple sweep packets corresponds to a respective TSF value of a set of multiple TSF values.

Aspect 83: The method of any of aspects 71-82, further including: receiving the one or more sweep packets for the beam sweeping procedure, where the one or more sweep packets are associated with one or more respective TSF values, and the report is transmitted in accordance with receiving the one or more sweep packets and the sweep packet satisfying a signal strength threshold.

Aspect 84: The method of aspect 83, where the report is transmitted via the first link, via the second link, or both.

Aspect 85: The method of either of aspects 83 or 84, where the report is transmitted via a multi-STA BA frame.

Aspect 86: The method of any of aspects 83-85, further including: monitoring a transmit period for the one or more sweep packets via the second link, where the transmit period is common to a set of multiple non-AP MLDs.

Aspect 87: The method of aspect 86, further including: receiving, via the first link, a trigger indication associated with the transmit period, where the report is transmitted via the first link in accordance with the trigger indication.

Aspect 88: The method of aspect 86, further including: receiving, via the first link, a TF associated with the transmit period.

Aspect 89: The method of aspect 88, where: the TF includes at least one of an MU-BAR, a basic TF, a BSRP, and a short feedback poll variant; the TF indicates a dedicated RU for transmission of the report, an RA-RU for transmission of the report, or both; or any combination thereof.

Aspect 90: The method of aspect 89, where the report is transmitted via the RA-RU in accordance with an AID value dedicated for beamforming feedback reception for the second link.

Aspect 91: The method of any of aspects 88-90, further including: receiving, via the first link, a short feedback report poll, a BSRP, or both associated with beam training feedback; and transmitting, via the first link, a response frame in accordance with the short feedback report poll, the BSRP, or both indicating a training mode for the non-AP MLD, where the TF indicates a dedicated RU for the non-AP MLD in accordance with the response frame indicating that the training mode is associated with a beam training procedure.

Aspect 92: The method of any of aspects 88-91, where a TB-PPDU that includes the report is transmitted via the first link in accordance with the TF.

Aspect 93: The method of any of aspects 83-92, further including: receiving, via the first link, an indication of a channel access period associated with feedback for the beam sweeping procedure, where the report is transmitted in accordance with the channel access period.

Aspect 94: The method of any of aspects 83-93, further including: receiving an indication of an updated TSF value for the first link of the AP MLD or the second link of the AP MLD, where the second TSF value associated with the reception of the sweep packet is corrected in accordance with the updated TSF value.

Aspect 95: The method of any of aspects 83-94, further including: receiving, via the first link, a TSF poll frame indicating the non-AP MLD, where the report is transmitted in accordance with the TSF poll frame and is transmitted via a frequency tone that is mapped to the second TSF value associated with the reception of the sweep packet.

Aspect 96: The method of any of aspects 83-95, further including: receiving one or more poll messages corresponding to the one or more sweep packets, where the report is transmitted in accordance with a poll message of the one or more poll messages corresponding to the second TSF value associated with the reception of the sweep packet.

Aspect 97: The method of any of aspects 71-96, where: the second TSF value associated with the reception of the sweep packet is further associated with the first link and the first TSF value associated with the second link; or the second TSF value associated with the reception of the sweep packet is further associated with the second link.

Aspect 98: The method of any of aspects 71-97, further including: operating in an NSA mode, where the first link includes a partner link for the second link in the NSA mode.

Aspect 99: The method of any of aspects 71-98, further including: triggering the beam sweeping procedure in accordance with establishment of an association with the AP MLD, an inactivity timer for the non-AP MLD, a reference signal indicating beam misalignment for the second frequency band, or any combination thereof.

Aspect 100: The method of any of aspects 71-99, further including: receiving a periodic update to a third TSF value for the first link of the AP MLD, a fourth TSF value for the second link of the AP MLD, or both, where the periodic update includes a partial TSF value or a full TSF value.

Aspect 101: The method of aspect 100, where: the periodic update includes at least one of an FD frame, a broadcast probe response frame, and a broadcast or individually addressed frame; a field including the partial TSF value or the full TSF value is integrity protected, encryption protected, or both; or any combination thereof.

Aspect 102: The method of any of aspects 71-101, where the first TSF value associated with the second link includes a zero value or a non-zero value indicating a TSF offset between the first link and the second link.

Aspect 103: The method of any of aspects 71-102, further including: receiving an indication of a start time for the beam sweeping procedure; and delaying the start time for the beam sweeping procedure in accordance with a periodicity at which the start time is indicated.

Aspect 104: A method for wireless communications at an AP MLD, including: communicating with a non-AP MLD via a first link corresponding to a first frequency band associated with omni-directional communications; transmitting, via the first link, an indication of a first TSF value associated with a second link between the AP MLD and the non-AP MLD; communicating, with the non-AP MLD, a report indicating a second TSF value associated with reception of a sweep packet of one or more sweep packets for a beam sweeping procedure; and communicating with the non-AP MLD via the second link corresponding to a second frequency band associated with directional communications in accordance with the beam sweeping procedure and the first TSF value associated with the second link.

Aspect 105: The method of aspect 104, further including: transmitting the one or more sweep packets, where the one or more sweep packets include a set of multiple sweep packets associated with a set of multiple respective transmit beams for the beam sweeping procedure, and where the report is received in accordance with the beam sweeping procedure.

Aspect 106: The method of aspect 105, further including: selecting a transmit beam for the second link that corresponds to the sweep packet of the one or more sweep packets in accordance with the report indicating the second TSF value associated with the reception of the sweep packet.

Aspect 107: The method of either of aspects 105 or 106, where the report is received via the first link, via the second link, or both.

Aspect 108: The method of any of aspects 105-107, where the report is received via a multi-STA BA frame.

Aspect 109: The method of any of aspects 105-108, further including: transmitting, via the first link, an indication of a channel access period associated with feedback for the beam sweeping procedure, where the report is received in accordance with the channel access period.

Aspect 110: The method of any of aspects 105-109, further including: transmitting an indication of an updated TSF value for the first link of the AP MLD or the second link of the AP MLD, where the second TSF value is corrected in accordance with the updated TSF value.

Aspect 111: The method of any of aspects 105-110, further including: transmitting, via the first link, a TSF poll frame indicating the non-AP MLD, where the report is received in accordance with the TSF poll frame and is received via a frequency tone that is mapped to the second TSF value associated with the reception of the sweep packet.

Aspect 112: The method of any of aspects 105-111, further including: transmitting a set of multiple poll messages corresponding to the set of multiple sweep packets, where the report is received in accordance with a poll message of the set of multiple poll messages corresponding to the second TSF value associated with the reception of the sweep packet.

Aspect 113: The method of any of aspects 105-112, where each sweep packet of the set of multiple sweep packets includes an LTF, a SIG, or both.

Aspect 114: The method of any of aspects 105-113, where each sweep packet of the set of multiple sweep packets includes a same pattern of bits.

Aspect 115: The method of aspect 114, further including: transmitting, via the first link, an indication of the same pattern of bits for the set of multiple sweep packets.

Aspect 116: The method of any of aspects 105-115, where the set of multiple TSF values are within a transmit period for the set of multiple sweep packets, and where the transmit period is common to a set of multiple non-AP MLDs.

Aspect 117: The method of aspect 116, further including: receiving a set of multiple reports associated with the set of multiple non-AP MLDs that indicate respective TSF values of the set of multiple TSF values in accordance with the transmit period.

Aspect 118: The method of aspect 117, where the set of multiple reports is received via a multi-STA BA frame.

Aspect 119: The method of either of aspects 117 or 118, further including: transmitting, via the first link, a trigger indication associated with the transmit period, where the set of multiple reports is received in accordance with the trigger indication.

Aspect 120: The method of either of aspects 117 or 118, further including: transmitting, via the first link, a TF associated with the transmit period.

Aspect 121: The method of aspect 120, where: the TF includes at least one of a MU-BAR, a basic TF, a BSRP, and a short feedback poll variant; the TF indicates one or more dedicated RUs, one or more RA-RUs, or a combination thereof for the set of multiple reports; or any combination thereof.

Aspect 122: The method of aspect 121, where receiving the set of multiple reports includes: receiving a report associated with the non-AP MLD via an RA-RU of the one or more RA-RUs in accordance with an AID value dedicated for beamforming feedback reception for the second link.

Aspect 123: The method of any of aspects 120-122, further including: transmitting, via the first link, a short feedback report poll, a BSRP, or both associated with beam training feedback; and receiving, via the first link, a response frame in accordance with the short feedback report poll, the BSRP, or both indicating a training mode for the non-AP MLD, where the TF indicates a dedicated RU for the non-AP MLD in accordance with the response frame indicating that the training mode is associated with a beam training procedure.

Aspect 124: The method of any of aspects 120-123, where a TB-PPDU includes the set of multiple reports in accordance with the TF.

Aspect 125: The method of any of aspects 116-124, where the set of multiple respective transmit beams are associated with a first subset of sectors for the AP MLD, the method further including: transmitting, within a second transmit period, a second set of multiple sweep packets associated with a second set of multiple respective transmit beams, where the second set of multiple respective transmit beams are associated with a second subset of sectors for the AP MLD different from the first subset of sectors.

Aspect 126: The method of any of aspects 105-125, where a sweep packet transmission for the set of multiple sweep packets corresponds to a respective TSF value of a set of multiple TSF values.

Aspect 127: The method of any of aspects 104-126, further including: receiving the one or more sweep packets for the beam sweeping procedure, where the one or more sweep packets are associated with one or more respective TSF values, and the report is transmitted in accordance with receiving the one or more sweep packets and the sweep packet satisfying a signal strength threshold.

Aspect 128: The method of aspect 127, where the report is transmitted via the first link, via the second link, or both.

Aspect 129: The method of either of aspects 127 or 128, where communicating the report further includes: aggregating the report with downlink data for the non-AP MLD.

Aspect 130: The method of any of aspects 127-129, where the report further indicates an updated TSF value for the first link of the AP MLD or the second link of the AP MLD.

Aspect 131: The method of any of aspects 127-130, further including: transmitting, via the first link, an indication of a time period for the beam sweeping procedure; and monitoring the time period for the one or more sweep packets via the second link, where the one or more respective TSF values are within the time period.

Aspect 132: The method of any of aspects 104-131, further including: transmitting a periodic update to the first TSF value associated with the second link of the AP MLD, where the periodic update to the first TSF value includes a partial TSF value or a full TSF value.

Aspect 133: The method of aspect 132, where: the periodic update includes at least one of an FD frame, a broadcast probe response frame, and a broadcast or individually addressed frame; a field including the partial TSF value or the full TSF value is integrity protected, encryption protected, or both; or any combination thereof.

Aspect 134: The method of any of aspects 104-133, where: the second TSF value associated with the reception of the sweep packet is further associated with the first link and the first TSF value associated with the second link; or the second TSF value associated with the reception of the sweep packet is further associated with the second link.

Aspect 135: The method of any of aspects 104-134, further including: transmitting, to an additional non-AP MLD, a preemption request associated with preempting a TXOP of the additional non-AP MLD via the first frequency band, where the report is communicated via the preempted TXOP.

Aspect 136: The method of any of aspects 104-135, where the report is communicated via one or more TDMed resources of a TXOP associated with an additional AP MLD via the first frequency band.

Aspect 137: The method of any of aspects 104-136, further including: selecting a feedback scheme in accordance with a first quantity of sectors associated with the beam sweeping procedure, a second quantity of non-AP MLDs associated with the beam sweeping procedure, or a combination thereof.

Aspect 138: The method of aspect 137, where the feedback scheme includes a preemption-based feedback scheme, a TXOP sharing-based feedback scheme, a first TSF polling feedback scheme associated with one or more STAs, a second TSF polling feedback scheme associated with one or more beams, or any combination thereof.

Aspect 139: The method of any of aspects 104-138, where the first TSF value includes a zero value or a non-zero value indicating a TSF offset between the first link and the second link.

Aspect 140: The method of any of aspects 104-139, further including: transmitting an indication of a start time for the beam sweeping procedure; and delaying the start time for the beam sweeping procedure in accordance with a periodicity at which the start time is indicated.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A non-access point (AP) multi-link device (MLD), comprising:
a processing system that includes processor circuitry and memory circuitry that stores code, the processing system configured to cause the non-AP MLD to:
communicate with an AP MLD via a first link corresponding to a first frequency band associated with omni-directional communications;
obtain, via the first link, an indication of a first timing synchronization function (TSF) value associated with a second link between the AP MLD and the non-AP MLD;
communicate, with the AP MLD, a report indicating a second TSF value associated with reception of a sweep packet of one or more sweep packets for a beam sweeping procedure; and
communicate with the AP MLD via the second link corresponding to a second frequency band associated with directional communications in accordance with the beam sweeping procedure and the first TSF value associated with the second link.

2. The non-AP MLD of claim 1, wherein the processing system is further configured to cause the non-AP MLD to:
output the one or more sweep packets, wherein the one or more sweep packets comprise a plurality of sweep packets associated with a plurality of respective transmit beams for the beam sweeping procedure, and wherein a sweep packet transmission for the plurality of sweep packets corresponds to a respective TSF value of a plurality of TSF values and the report is obtained in accordance with the beam sweeping procedure.

3. The non-AP MLD of claim 2, wherein the processing system is further configured to cause the non-AP MLD to:
select a transmit beam for the second link that corresponds to the sweep packet of the one or more sweep packets in accordance with the report indicating the second TSF value associated with the reception of the sweep packet.

4. (canceled)

5. The non-AP MLD of claim 2, wherein:
the report is obtained via the first link, via the second link, or both;
the report is aggregated with downlink data for the non-AP MLD;
the report is obtained via a multi-station (STA) block acknowledgment (BA) frame; or
any combination thereof.

6. The non-AP MLD of claim 2, wherein the processing system is further configured to cause the non-AP MLD to:
obtain, via the first link, an indication of a time period for the beam sweeping procedure, wherein the plurality of TSF values are within the time period.

7. (canceled)

8. (canceled)

9. The non-AP MLD of claim 1, wherein the processing system is further configured to cause the non-AP MLD to:
obtain the one or more sweep packets for the beam sweeping procedure, wherein the one or more sweep packets are associated with one or more respective TSF values, and the report is outputted in accordance with obtaining the one or more sweep packets and the sweep packet satisfying a signal strength threshold.

10. (canceled)

11. The non-AP MLD of claim 9, wherein the processing system is further configured to cause the non-AP MLD to:
monitor a transmit period for the one or more sweep packets via the second link, wherein the transmit period is common to a plurality of non-AP MLDs.

12. The non-AP MLD of claim 11, wherein the processing system is further configured to cause the non-AP MLD to:
obtain, via the first link, a trigger frame (TF) associated with the transmit period, wherein a trigger-based physical layer convergence protocol (PLCP) protocol data unit (TB-PPDU) that comprises the report is outputted via the first link in accordance with the TF.

13-15. (canceled)

16. The non-AP MLD of claim 9, wherein the processing system is further configured to cause the non-AP MLD to:
obtain, via the first link, an indication of a channel access period associated with feedback for the beam sweeping procedure, wherein the report is outputted in accordance with the channel access period.

17. The non-AP MLD of claim 9, wherein the processing system is further configured to cause the non-AP MLD to:
obtain an indication of an updated TSF value for the first link of the AP MLD or the second link of the AP MLD, wherein the second TSF value associated with the reception of the sweep packet is corrected in accordance with the updated TSF value.

18. The non-AP MLD of claim 9, wherein the processing system is further configured to cause the non-AP MLD to:
obtain, via the first link, a TSF poll frame indicating the non-AP MLD, wherein the report is outputted in accordance with the TSF poll frame and is outputted via a frequency tone that is mapped to the second TSF value associated with the reception of the sweep packet.

19. The non-AP MLD of claim 9, wherein the processing system is further configured to cause the non-AP MLD to:
obtain one or more poll messages corresponding to the one or more sweep packets, wherein the report is outputted in accordance with a poll message of the one or more poll messages corresponding to the second TSF value associated with the reception of the sweep packet.

20. (canceled)

21. (canceled)

22. The non-AP MLD of claim 1, wherein the processing system is further configured to cause the non-AP MLD to:
trigger the beam sweeping procedure in accordance with establishment of an association with the AP MLD, an inactivity timer for the non-AP MLD, a reference signal indicating beam misalignment for the second frequency band, or any combination thereof.

23-26. (canceled)

27. An access point (AP) multi-link device (MLD), comprising:
a processing system that includes processor circuitry and memory circuitry that stores code, the processing system configured to cause the AP MLD to:
communicate with a non-AP MLD via a first link corresponding to a first frequency band associated with omni-directional communications;
output, via the first link, an indication of a first timing synchronization function (TSF) value associated with a second link between the AP MLD and the non-AP MLD;
communicate, with the non-AP MLD, a report indicating a second TSF value associated with reception of a sweep packet of one or more sweep packets for a beam sweeping procedure; and
communicate with the non-AP MLD via the second link corresponding to a second frequency band associated with directional communications in accordance with the beam sweeping procedure and the first TSF value associated with the second link.

28. The AP MLD of claim 27, wherein the processing system is further configured to cause the AP MLD to:
output the one or more sweep packets, wherein the one or more sweep packets comprise a plurality of sweep packets associated with a plurality of respective transmit beams for the beam sweeping procedure, and wherein a sweep packet transmission for the plurality of sweep packets corresponds to a respective TSF value of a plurality of TSF values and the report is obtained in accordance with the beam sweeping procedure.

29. The AP MLD of claim 28, wherein the processing system is further configured to cause the AP MLD to:
select a transmit beam for the second link that corresponds to the sweep packet of the one or more sweep packets in accordance with the report indicating the second TSF value associated with the reception of the sweep packet.

30. (canceled)

31. The AP MLD of claim 28, wherein the processing system is further configured to cause the AP MLD to:
output, via the first link, an indication of a channel access period associated with feedback for the beam sweeping procedure, wherein the report is obtained in accordance with the channel access period.

32. The AP MLD of claim 28, wherein the processing system is further configured to cause the AP MLD to:
output an indication of an updated TSF value for the first link of the AP MLD or the second link of the AP MLD, wherein the second TSF value is corrected in accordance with the updated TSF value.

33-36. (canceled)

37. The AP MLD of claim 28, wherein the plurality of TSF values are within a transmit period for the plurality of sweep packets, and wherein the transmit period is common to a plurality of non-AP MLDs.

38. The AP MLD of claim 37, wherein the processing system is further configured to cause the AP MLD to:
obtain a plurality of reports associated with the plurality of non-AP MLDs that indicate respective TSF values of the plurality of TSF values in accordance with the transmit period.

39-44. (canceled)

45. The AP MLD of claim 27, wherein the processing system is further configured to cause the AP MLD to:
obtain the one or more sweep packets for the beam sweeping procedure, wherein the one or more sweep packets are associated with one or more respective TSF values, and the report is outputted in accordance with obtaining the one or more sweep packets and the sweep packet satisfying a signal strength threshold.

46-48. (canceled)

49. The AP MLD of claim 45, wherein the processing system is further configured to cause the AP MLD to:
output, via the first link, an indication of a time period for the beam sweeping procedure; and
monitor the time period for the one or more sweep packets via the second link, wherein the one or more respective TSF values are within the time period.

50-52. (canceled)

53. The AP MLD of claim 27, wherein the processing system is further configured to cause the AP MLD to:
output, to an additional non-AP MLD, a preemption request associated with preempting a transmission opportunity of the additional non-AP MLD via the first frequency band, wherein the report is communicated via the preempted transmission opportunity.

54. (canceled)

55. The AP MLD of claim 27, wherein the processing system is further configured to cause the AP MLD to:
select a feedback scheme in accordance with a first quantity of sectors associated with the beam sweeping procedure, a second quantity of non-AP MLDs associated with the beam sweeping procedure, or a combination thereof.

56. The AP MLD of claim 55, wherein the feedback scheme comprises a preemption-based feedback scheme, a transmit opportunity (TXOP) sharing-based feedback scheme, a first TSF polling feedback scheme associated with one or more wireless stations (STAs), a second TSF polling feedback scheme associated with one or more beams, or any combination thereof.

57. (canceled)

58. (canceled)

59. A method for wireless communications at a non-access point (AP) multi-link device (MLD), comprising:
communicating with an AP MLD via a first link corresponding to a first frequency band associated with omni-directional communications;
receiving, via the first link, an indication of a first timing synchronization function (TSF) value associated with a second link between the AP MLD and the non-AP MLD;
communicating, with the AP MLD, a report indicating a second TSF value associated with reception of a sweep packet of one or more sweep packets for a beam sweeping procedure; and
communicating with the AP MLD via the second link corresponding to a second frequency band associated with directional communications in accordance with the beam sweeping procedure and the first TSF value associated with the second link.

60. The method of claim 59, further comprising:
transmitting the one or more sweep packets, wherein the one or more sweep packets comprise a plurality of sweep packets associated with a plurality of respective transmit beams for the beam sweeping procedure, and wherein a sweep packet transmission for the plurality of sweep packets corresponds to a respective TSF value of a plurality of TSF values and the report is received in accordance with the beam sweeping procedure.

61-66. (canceled)

67. The method of claim 59, further comprising:
receiving the one or more sweep packets for the beam sweeping procedure, wherein the one or more sweep packets are associated with one or more respective TSF values, and the report is transmitted in accordance with receiving the one or more sweep packets and the sweep packet satisfying a signal strength threshold.

68-84. (canceled)

85. A method for wireless communications at an access point (AP) multi-link device (MLD), comprising:
communicating with a non-AP MLD via a first link corresponding to a first frequency band associated with omni-directional communications;
transmitting, via the first link, an indication of a first timing synchronization function (TSF) value associated with a second link between the AP MLD and the non-AP MLD;
communicating, with the non-AP MLD, a report indicating a second TSF value associated with reception of a sweep packet of one or more sweep packets for a beam sweeping procedure; and
communicating with the non-AP MLD via the second link corresponding to a second frequency band associated with directional communications in accordance with the beam sweeping procedure and the first TSF value associated with the second link.

86. The method of claim 85, further comprising:
transmitting the one or more sweep packets, wherein the one or more sweep packets comprise a plurality of sweep packets associated with a plurality of respective transmit beams for the beam sweeping procedure, and wherein a sweep packet transmission for the plurality of sweep packets corresponds to a respective TSF value of a plurality of TSF values and the report is received in accordance with the beam sweeping procedure.

87-116. (canceled)
